(19) United States
(12) Patent Application Publication
(10) Pub. No.: US 2019/0050854 A1
(43) Pub. Date: Feb. 14, 2019

(54) BLOCKCHAIN-BASED DIGITAL DATA EXCHANGE

(71) Applicant: Intel Corporation, Santa Clara, CA (US)

(72) Inventors: Xue Yang, San Jose, CA (US); Florence Pon, Folsom, CA (US); Naissa Conde, San Jose, CA (US); Wei Yee Koay, Bayan Lepas (MY); Maruti Gupta Hyde, Portland, OR (US)

(21) Appl. No.: 16/147,012

(22) Filed: Sep. 28, 2018

(51) Int. Cl. G06Q 20/38; G06F 17/30; H04L 9/08

(52) U.S. Cl. CPC G06Q 20/382; G06F 17/30283; H04L 2209/38; H04L 9/0825; G06F 17/30194

(57) ABSTRACT

Example blockchain-based digital data exchanges including example data publisher endpoint devices and example data subscriber endpoint systems are disclosed herein. Example data publisher endpoint devices disclosed herein include a datamart publisher client to transmit a message to a data exchange to publish availability of data to be accessed from data storage associated with the data publisher endpoint device, and in response to a request from a data subscriber endpoint system, initiate a transaction to provide the data subscriber endpoint system with access to the data. Disclosed example data publisher endpoint devices also include a blockchain client to publish a record of the transaction to a blockchain network when the transaction is validated by the datamart publisher client, the record to be included in a blockchain implemented by the blockchain network.

### FIELD OF THE DISCLOSURE

This disclosure relates generally to sharing data in computer networks and, more particularly, to a blockchain-based digital data exchange.

### BACKGROUND

Deep learning solutions for big data analytics depend on the availability of a large amount of data to enable building of the machine learning models and extracting of patterns and/or other information from the data. Thus, a lack of sufficient data may prevent the use of deep learning solutions or other machine learning techniques in some data analytics applications. Also, data aggregation systems that make data available to such deep learning solutions or other machine learning techniques can be susceptible to data privacy breaches. In the past, the data that is improperly released through such a breach and/or the entity or entities improperly obtaining and using the breached data may be undetectable and/or untraceable.

### BRIEF DESCRIPTION OF THE DRAWINGS

FIG. 1 is a block diagram of an example blockchain-based digital data exchange system implemented in accordance with the teachings of this disclosure.

FIG. 2 is a block diagram of an example datamart publisher client included in an example data publisher endpoint of the blockchain-based digital data exchange system of FIG. 1.

FIG. 3 is a block diagram of an example datamart subscriber client included in an example data subscriber endpoint of the blockchain-based digital data exchange system of FIG. 1.

FIG. 4 is a block diagram of an example blockchain client that may be used to implement the data publisher endpoint and/or the data subscriber endpoint of the blockchain-based digital data exchange system of FIG. 1.

FIG. 5 is an example message sequence diagram illustrating example operation of the blockchain-based digital data exchange system of FIG. 1.

FIG. 6 is a flowchart representative of example computer readable instructions that may be executed to implement the example data publisher endpoint FIG. 1.

FIG. 7 is a flowchart representative of example computer readable instructions that may be executed to implement the example data subscriber endpoint FIG. 1.

FIG. 8 is a block diagram of an example processor platform structured to execute the example computer readable instructions of FIG. 6 to implement the example data publisher endpoint FIG. 1.

FIG. 9 is a block diagram of an example processor platform structured to execute the example computer readable instructions of FIG. 7 to implement the example data subscriber endpoint FIG. 1.

The figures are not to scale. In general, the same reference numbers will be used throughout the drawing(s) and accompanying written description to refer to the same or like parts, elements, etc.

### DETAILED DESCRIPTION

Example methods, apparatus, systems and articles of manufacture (e.g., physical storage media) to implement a blockchain-based digital data exchange are disclosed herein. An example blockchain-based digital data exchange system implemented in accordance with teachings of this disclosure enables a data publisher (e.g., a data seller, a data lessor, a data sharer, etc.) to provide (e.g., sell, lease, share, etc.) data to a data subscriber (e.g., a data buyer, a data lessee, a data recipient, etc.) through robust data transactions. The data transactions implemented by such a blockchain-based digital data exchange system can enable transaction conditions to be specified and enforced by the data publisher and/or the data subscriber. Furthermore, the data transactions implemented by such a blockchain-based digital data exchange system can be tracked in a reliable, distributed manner such that improperly accessed data (e.g., obtained through a data privacy breach) can be traced back to identify the entity or entities that improperly accessed the data.

Some example blockchain-based digital data exchange systems implemented in accordance with teachings of this disclosure include data publisher endpoint devices associated with data providers operating in the system and data subscriber endpoint systems associated with data subscribers operating in the system. Example data publisher endpoint devices disclosed herein include an example datamart publisher client to transmit a message to a data exchange to publish availability of data to be accessed from data storage associated with the data publisher endpoint device. The datamart publisher client in such examples is also to initiate a transaction to provide a data subscriber endpoint system with access to the data in response to a request from the data subscriber endpoint system. Disclosed example publisher endpoint devices also include an example blockchain client to publish a record of the transaction to an example blockchain network when the transaction is validated by the datamart publisher client. In some examples, the record is to be included in a blockchain implemented by the blockchain network. Some disclosed example publisher endpoint devices further include a data producing application to provide the data to the data storage associated with the endpoint device.

In some disclosed examples, the datamart publisher client is further to determine a label for the data (e.g., based on a hash of the data), determine a price for accessing the data and include the label and the price in the message to transmit to the data exchange to publish the availability of the data.

In some such disclosed examples, the request from the data subscriber endpoint system includes a public encryption key associated with the data subscriber endpoint system. In some such examples, the datamart publisher client is to encrypt the data with the public encryption key to generate encrypted data, and transmit a second message to the data subscriber endpoint system to initiate the transaction. In some examples, the second message is to specify a location at which the encrypted data can be accessed by the data subscriber endpoint system. Also, in some disclosed examples, the datamart publisher client is to receive a response to the second message from the data subscriber endpoint system, with the response to indicate whether the transaction is accepted by the data subscriber endpoint system.

Some disclosed example data publisher endpoint devices further include a smart contract application to validate the transaction when the response to the second message indicates the transaction has been accepted by the data subscriber endpoint system. For example, the smart contract application can confirm payment of the price by the data subscriber endpoint system to validate the transaction. Additionally or alternatively, in some disclosed examples, the datamart publisher client is further to determine a condition for accessing the data and to include the condition in the message to transmit to the data exchange to publish the availability of the data. In some such examples, the smart contract application is to monitor access of the data by the data subscriber endpoint system to enforce the condition after the transaction has been validated. In some such examples, the blockchain client is to publish another record to the block chain network to update (e.g., terminate) the transaction when the smart contract application determines the condition has been violated by the data subscriber endpoint system. For example, the condition may specify a duration during which the data is permitted to be accessed, a frequency at which the data is permitted to be accessed, etc.

In some disclosed examples, the record to be published to the blockchain network is to include a transaction identifier, the label for the data (e.g., based on a hash of the data), the price for accessing the data, an identifier associated with the particular data publisher endpoint device providing the data and an identifier associated with the particular data subscriber endpoint system receiving the data. In some such disclosed examples, the blockchain client is to transmit the record to computing nodes included in the blockchain network to publish the record to the blockchain network. In some such disclosed examples, the blockchain client is also to monitor the blockchain for other records including corresponding labels matching the particular data label included in the published record, and will notify the datamart publisher client when at least one other record in the blockchain includes a corresponding label matching the particular data label included in the published record (which may indicate this data is a part of another, potentially unauthorized transaction).

Example data subscriber endpoint systems disclosed herein include a datamart subscriber client to access a notification from a data exchange. The notification is to indicate that a data publisher endpoint device has published availability of data associated with the data publisher endpoint device. The datamart subscriber client in such examples is also to transmit a request to the data publisher endpoint device to initiate a transaction to provide the data subscriber endpoint system with access to the data. Disclosed example data subscriber endpoint systems also include a blockchain client to publish a record of the transaction to a blockchain network when the transaction is validated by the datamart subscriber client. In some examples, the record is to be included in a blockchain implemented by the blockchain network. Some disclosed example subscriber endpoint systems further include a data processing application to process the accessed data.

In some disclosed examples, the datamart subscriber client is to transmit a message to the data exchange to subscribe for data availability notifications. In some disclosed examples, the datamart subscriber client is to compare the notification from the data exchange to one or more criteria to determine whether to request initiation of the transaction to provide the data subscriber endpoint system with access to the data.

In some disclosed examples, the datamart subscriber client is to access a message received from the data publisher endpoint device in response to the request transmitted to the data publisher endpoint device. In some examples, the message is to specify a location at which the data can be accessed by the data subscriber endpoint system. In some such examples, the datamart subscriber client is to access the data from the location specified in the message. Furthermore, in some such disclosed examples, the request transmitted to the data publisher endpoint device is to include a public encryption key associated with the data subscriber endpoint system. In some such examples, the datamart subscriber client is further to decrypt the data accessed from the location specified in the message from the data publisher endpoint device, with the datamart subscriber client to decrypt the data based on a private encryption key associated with the public encryption key.

Some disclosed example data subscriber endpoint systems further include a smart contract application to evaluate the data accessed from the location specified in the message from the data publisher endpoint device to determine whether to validate the transaction. In some such examples, the smart contract application is to evaluate the data based on a condition specified for the data in the notification from the data exchange. For example, the condition may specify a quantity of the data. a duration covered by the data, etc. Additionally or alternatively, in some disclosed examples, the smart contract application is further to monitor the data accessed from the location specified in the message from the data publisher endpoint device to enforce the condition after the transaction has been validated. In some such examples, the blockchain client is to publish another record to the block chain network to update (e.g., terminate) the transaction when the smart contract application determines the data does not satisfy the condition.

These and other example methods, apparatus, systems and articles of manufacture (e.g., physical storage media) to implement a blockchain-based digital data exchange are disclosed in further detail below.

As noted above, deep learning solutions for big data analytics depend on the availability of a large amount of data to enable building of the machine learning models and extracting of patterns and other information from the data. To support the use of deep learning solutions and/or other machine learning techniques in a given data analytics application, data aggregation system may be employed to attempt to obtain (e.g., aggregate) the necessary underlying data. However, prior data aggregation systems are often limited resource intensive, trial-and-error approaches for obtaining data. For example, such prior data aggregation systems may rely on user trials to obtain the necessary data, with a user trial involving contacting a universe of users to identify a group of users willing to participate in the user trial, obtaining signed release forms and/or other agreements from the group of users, and then collecting the data from the group of users (e.g., at a specified time) once the conditions of the trial are met. Such an approach can expend considerable computational resources to identify and contact the universe of users, coordinate obtaining the release forms/agreements from the group of user, schedule the collection of data from the group of users, etc. Furthermore, if sufficient data is not collected, additional computational resources will be expended attempting to find additional users to fill the gap in the collected data.

As also noted above, the data aggregation systems that make data available to deep learning or other machine learning solutions can be susceptible to data privacy breaches and/or other improper accesses of the collected data. Past data aggregation systems provide few, if any, mechanisms for detecting the entities responsible for such breaches. Past data aggregation systems also provide few, if any, mechanisms for tracing the use of the data obtained improperly by such entities.

In contrast with such prior data aggregation systems, example blockchain-based digital data exchange systems implemented in accordance with teachings of this disclosure allow users (e.g., individuals, companies, etc.), referred to herein as data providers, to proactively offer to provide (e.g., sell, lease, share, etc.) their data (e.g., generated or otherwise associated with their respective data provider endpoints) to recipients (e.g., individuals, companies, etc.), referred to herein as data subscribers, that are interested in obtaining (e.g., buying, leasing, borrowing, etc.) the data for use in one or more applications, such as deep learning solutions for big data analytics. Disclosed example blockchain-based digital data exchange systems enable data providers to obtain compensation (e.g., payment, rewards, etc.) for providing access to data generated or otherwise associated with their respective data provider endpoints and/or to set one or more other conditions to be satisfied to gain and/or retain access to the data generated or otherwise associated with their respective data provider endpoints. Disclosed example blockchain-based digital data exchange systems enable data subscriber endpoints to subscribe to data availability notifications identifying data being offered by data providers, as well as one or more characteristics of the data and/or one or more conditions to be satisfied to gain and/or retain access to the data. Such features of example blockchain-based digital data exchange systems disclosed herein alleviate the need to employ resource intensive, trial-and-error approaches for identifying users, reaching agreement with the users and obtaining their data. This is because the data being offered for access and the conditions for access are proactively announced by the data provider endpoints and searchable/filterable in the disclosed example blockchain-based digital data exchange systems.

Moreover, example blockchain-based digital data exchange systems implemented in accordance with teachings of this disclosure are rooted in a blockchain that records each data transaction in the system. The records maintained in the blockchain identify the particular data the was the subject of each published transaction, as well as the data provider and the data subscriber participating in the transaction. The records are maintained in the blockchain in a distributed manner that is resistant to tampering, corruption, etc. Because the records identify the particular data the was the subject of each published transaction, as well as the data provider and the data subscriber participating in each transaction, the blockchain records can be monitored to detect if improperly accessed data becomes the subject of a transaction in the system and, if so, the participants in the improper transaction. Thus, unlike prior data aggregation systems, example blockchain-based digital data exchange systems disclosed herein provide mechanisms for detecting the entities responsible for data breaches and for tracing the use of the data obtained improperly by such entities.

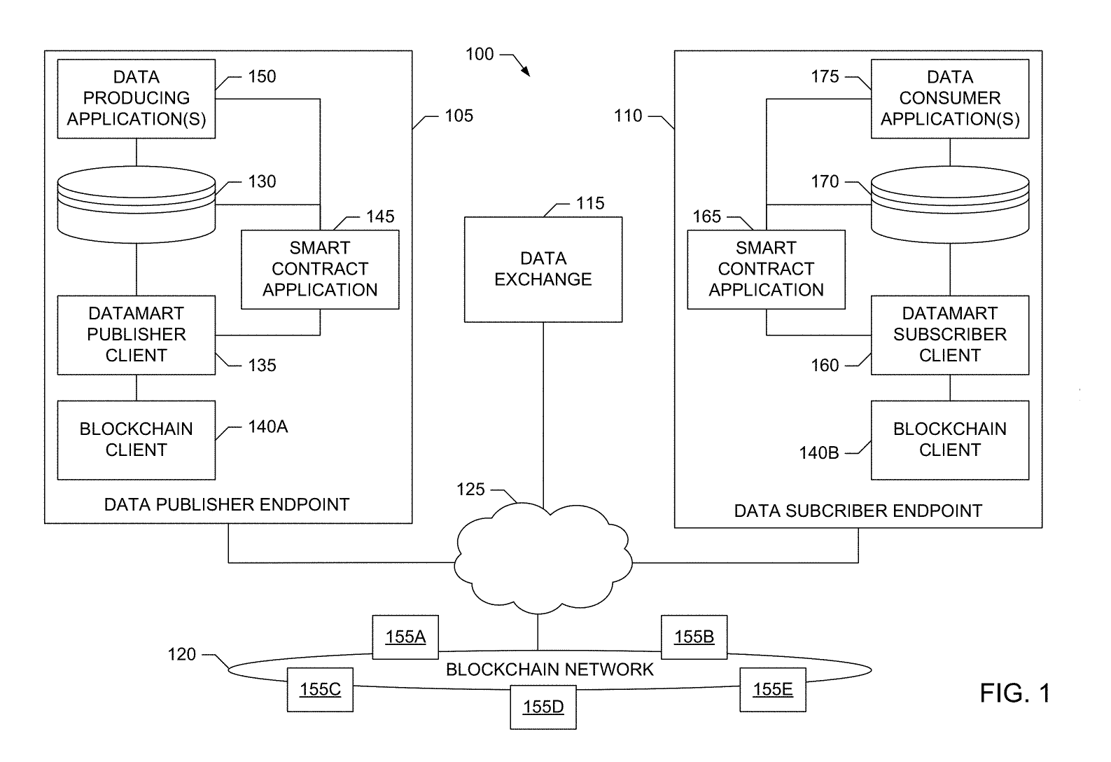

Turning to the figures, a block diagram of an example blockchain-based digital data exchange system 100 implemented in accordance with teachings of this disclosure is illustrated in FIG. 1. The blockchain-based digital data exchange system 100 of FIG. 1 includes an example data publisher endpoint device 105, an example data subscriber endpoint system 110, an example data exchange 115 and an example blockchain network 120 in communication via an example communication network 125. As disclosed in further detail below, the data publisher endpoint device 105 of the illustrated example communicates with the data exchange 115 to publish the availability of data accessible from an example data storage 130 associated with the data publisher endpoint device 105, as well as characteristics of the data and/or any condition(s) governing access to the data. The data subscriber endpoint system 110 of the illustrated example receives data availability notifications from the data exchange 115, such as a notification indicating data is available from the data publisher endpoint device 105. If the data characteristic(s) and/or condition(s) included in the notification indicate that the data available from (offered by) the data publisher endpoint device 105 meet one or more criteria, the data subscriber endpoint system 110 contacts the data publisher endpoint device 105 to initiate a transaction to provide the data subscriber endpoint system 110 with access that data. In the illustrated example, if the transaction is validated by the data publisher endpoint device 105 and/or the data subscriber endpoint system 110, a record of the transaction is provided to the blockchain network 120 for inclusion in a blockchain implemented by the blockchain network 120. Further operational details concerning the blockchain-based digital data exchange system 100 of FIG. 1 are provided below.

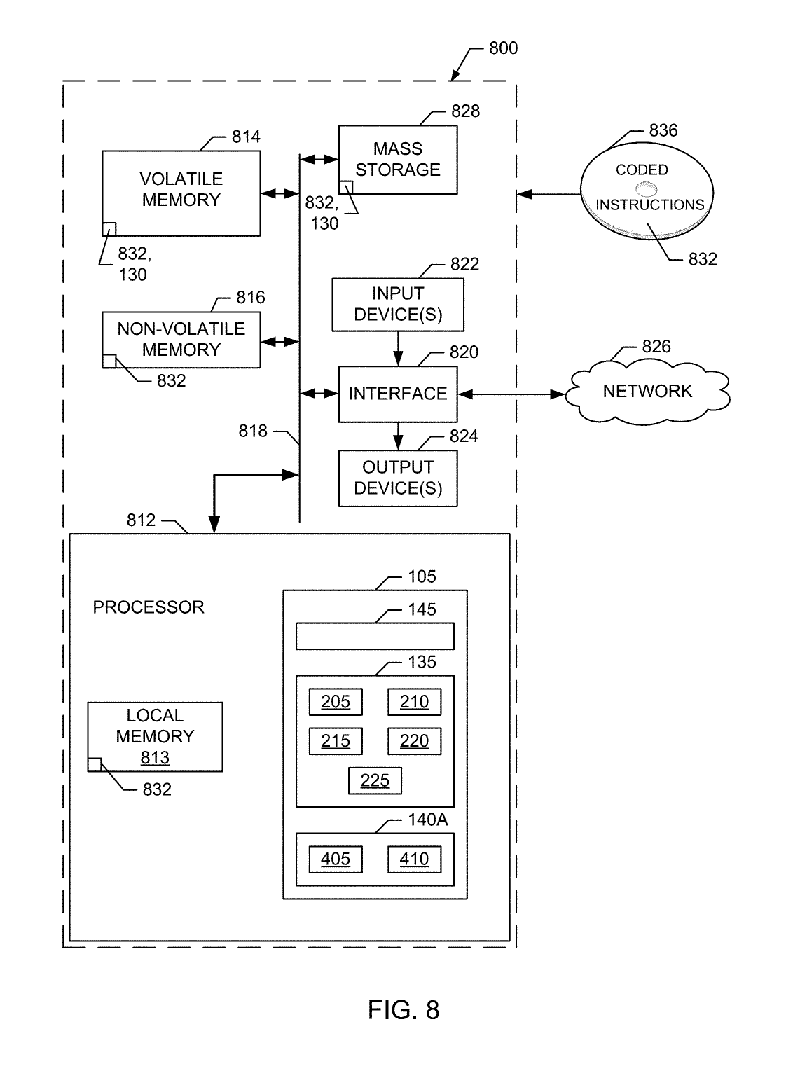

The example data publisher endpoint device 105 of FIG. 1 can be implemented by any suitably configured, adapted or otherwise structured computing device (e.g., a smartphone, a tablet computer, a notebook computer, a desktop computer, a smart appliance, etc.), server, data center, cloud service, etc. For example, the data publisher endpoint device 105 of FIG. 1 can be implemented by the example processor platform 800 of FIG. 8, which is described in further detail below. In the illustrated example of FIG. 1, the data publisher endpoint device 105 is configured, adapted or otherwise structured to include an example datamart publisher client 135, an example blockchain client 140A, an example smart contract application 145, one or more example data producing applications 150 and the example data storage 130.

In the illustrated example of FIG. 1, the data producing application(s) 150 correspond to any application that produces data to be made available (to be offered) by the data publisher endpoint device 105. The data producing application(s) 150 can be any application executed or otherwise associated with the data publisher endpoint device 105. For example, the data producing application(s) 150 can include, but are not limited to, health applications that create and store biometric and/or other user performance data, applications that log data, etc. In the illustrated example of FIG. 1, the data producing application(s) 150 store their respective data in the storage device 130. The storage device 130 of the illustrated example can be implemented by any number and/or types of storage devices, memories, etc. For example, the storage device 130 can be implemented by the example volatile memory 814 and/or the example mass storage device(s) 828 of FIG. 8, which are described in further detail below.

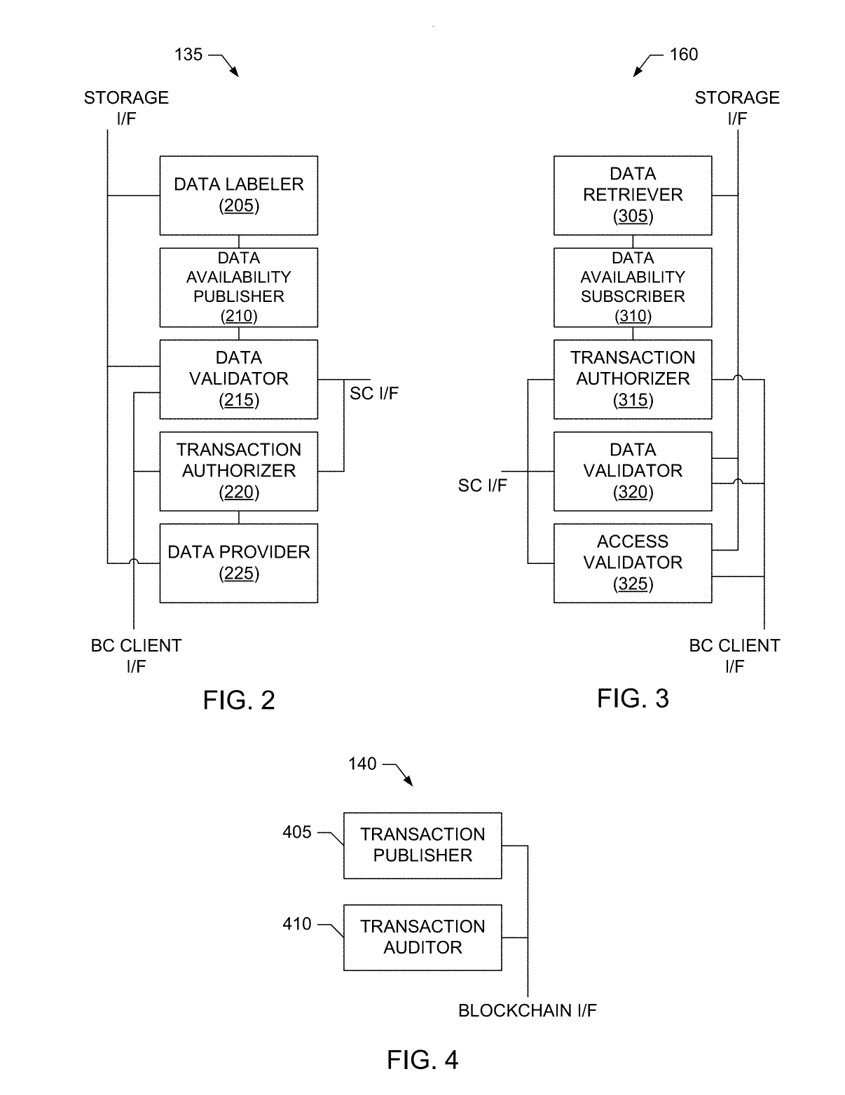

In the illustrated example of FIG. 1, the datamart publisher client 135 is responsible for identifying the data to be made accessible by the data publisher endpoint device 105, specifying conditions governing access to the data, publishing the availability of the data to the data exchange 115, initiating a transaction to permit a data subscriber endpoint, such as the data subscriber endpoint system 110, to access the data, etc. Implementation and operation of the datamart publisher client 135 of the illustrated example is described in further detail below and in connection with FIG. 2.

In the illustrated example of FIG. 1, the digital data exchange system 100 is built upon the example blockchain network 120, which implements a blockchain. The blockchain network 120 of the illustrated example includes any number of example computing nodes 155A-E, which may be implemented by any types and/or number of computing devices, servers, data centers, cloud services, etc. The blockchain network 120 can implement a public blockchain, a private blockchain, or any number or combination thereof. A blockchain is a distributed computing architecture in which each computing node 155-E records the same transactions, which are grouped into blocks that are added one at a time to the blockchain. Each block of the blockchain contains a mathematical proof to verify that it follows from the preceding block in the blockchain. This feature of adding blocks one at a time to the blockchain and including data in the blocks to verify their positions in the blockchain enable the blockchain to maintain a distributed database of records that can be kept in consensus. Furthermore, because data transactions in the digital data exchange system 100 are published to the blockchain network 120 for inclusion in the blockchain, an owner or other data provider of given data can trace the blocks of the blockchain to identify what entity or entities has/have accessed the given data in the system 100 and when.

As such, the blockchain client 140A is included in the data publisher endpoint device 105 of the illustrated example to publish data transaction records to the blockchain implemented by the blockchain network 120, with the data transaction records being associated with data provided by the data publisher endpoint device 105. In some examples, the blockchain client 140A also monitors the blockchain implemented by the blockchain network 120 to identify other records in the blockchain that correspond to data owned and/or being provided by the data publisher endpoint device 105. If such records are found, the blockchain client 140A can notify the datamart publisher client 135, which takes appropriate action to notify a user of the data publisher endpoint device 105 of the potential improper access of the data (e.g., by presenting a message via a user interface, transmitting a message to a user device, etc.). Implementation and operation of the blockchain client 140A of the illustrated example is described in further detail below and in connection with FIG. 4.

In the illustrated example of FIG. 1, the data publisher endpoint device 105 includes the smart contract application 145, which is implemented using any appropriate smart contracting technology, to validate a transaction to provide a data subscriber endpoint, such as the data subscriber endpoint system 110, which access to data stored in the data storage 130. For example, the datamart publisher client 135 may program the smart contract application 145 with one or more conditions governing access to the data, such as a price for accessing the data, a quantity of data permitted to be accessed, a duration of time during which the data is permitted to be accessed, etc. In such an example, after a data transaction has been initiated by the datamart publisher client 135 and accepted by the data subscriber endpoint system 110, the smart contract application 145 verifies whether the relevant condition(s) governing access to the data have been met. For example, the smart contract application 145 may be programmed to query a payment service to confirm that the price for accessing the data has been paid by the data subscriber endpoint system 110. If the smart contract application 145 confirms the relevant condition(s) have been met, the smart contract application 145 validates the transaction and causes the blockchain client 140A to publish a record of the transaction to the blockchain network 120. Otherwise, the smart contract application 145 causes the transaction to be terminated. Furthermore, in some examples, if one or more of the relevant condition(s) have not been met, the smart contract application 145 is programmed to treat such an event as a contract breach and enforce a penalty condition. For example, the smart contract application 145 can be programmed to interface with a payment service to cause an appropriate payment or credit to be made to compensate for the contract breach.

In some examples, the smart contract application 145 is programmed by the datamart publisher client 135 to continue to monitor access of data, which is the subject of a validated transaction, after the transaction has been validated to enforce the relevant condition(s) governing access to the data by the data subscriber endpoint system 110. For example, the smart contract application 145 may be programmed with conditions governing the frequency with which the data is permitted to be accessed, the amount of data that is permitted to be accessed, the duration of time during which the data is permitted to be accessed, etc. For example, if the data subscriber endpoint system 110 has agreed to lease data made available by the data publisher endpoint device 105 (e.g., stored in the data storage 130), the smart contract application 145 may be programmed to monitor whether an expiration time of the lease has elapsed. When the expiration time has elapsed, the smart contract application 145 may block access to the data by the data subscriber endpoint system 110 (e.g., by encrypting the data with an encryption key unknown to the data subscriber endpoint system 110, by blocking messages (e.g., data requests) originating from the data subscriber endpoint system 110, etc.). In some examples, if the smart contract application 145 determines one or more of the relevant conditions have been breached after the transaction has been validated, the smart contract application 145 can enforce a penalty condition, as described above.

In some examples, the smart contract application 145 is programmed to monitor data, which is the subject of an initiated or validated transaction, to enforce relevant condition(s) to be met by the data publisher endpoint device 105. Such condition(s) can be specified by the datamart publisher client 135 when publishing the availability of the data, and/or can be specified by the data subscriber endpoint system 110 in message sent to request initiation of the transaction and/or acceptance of the transaction. For example, if the data that is the subject of the transaction is collected and/or generated in real-time from the data producing application 150, the smart contract application 145 may be programmed to interface with and monitor the data producing application 150 as shown. For example, the smart contract application 145 may monitor the data collection and/or generation process, the frequency of data collection and/or generation, the time and/or duration of data collection and/or generation, etc., to ensure the data is being collected and/or generated by the data producing application 150 in accordance with the relevant condition(s) governing the transaction, thereby enforcing the relevant condition(s). If, for example, one or more of the relevant condition(s) are not met, such as the data producing application 150 not being activated at the agreed-upon time, frequency or otherwise in accordance with agreed-upon procedures, the smart contract application 145 can detect this breach of the relevant condition(s) and enforce a penalty condition, as described above.

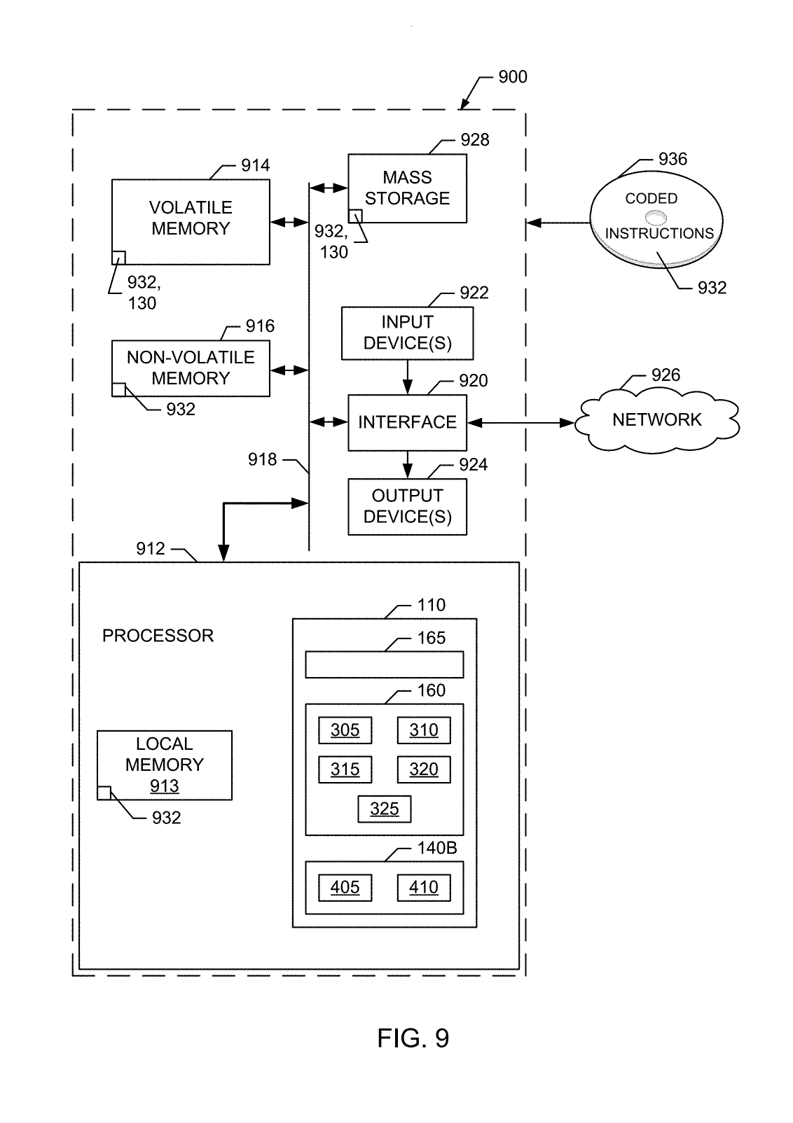

The example data subscriber endpoint system 110 of FIG. 1 can be implemented by any suitably configured, adapted or otherwise structured computing device (e.g., a smartphone, a tablet computer, a notebook computer, a desktop computer, a smart appliance, etc.), server, data center, cloud service, etc. For example, the data subscriber endpoint system 110 of FIG. 1 can be implemented by the example processor platform 900 of FIG. 9, which is described in further detail below. In the illustrated example of FIG. 1, the data subscriber endpoint system 110 is configured, adapted or otherwise structured to include an example datamart subscriber client 160, an example blockchain client 140B, an example smart contract application 165, one or more example data producing applications 175 and an example data storage 170.

In the illustrated example of FIG. 1, the data consumer application(s) 175 correspond to any application that utilize data accessed by the data subscriber endpoint system 110 from a data publisher endpoint, such as the data publisher endpoint device 105. The data consumer application(s) 175 can be any application executed or otherwise associated with the data subscriber endpoint system 110. For example, the data consumer application(s) 175 can include, but are not limited to, one or more deep learning applications, one or more machine learning applications, etc. In the illustrated example of FIG. 1, the data accessed by the data subscriber endpoint system 110 from a data publisher endpoint, such as the data publisher endpoint device 105, is stored in the storage device 170. The storage device 170 of the illustrated example can be implemented by any number and/or types of storage devices, memories, etc. For example, the storage device 170 can be implemented by the example volatile memory 914 and/or the example mass storage device(s) 928 of FIG. 9, which are described in further detail below.

In the illustrated example of FIG. 1, the datamart subscriber client 160 is responsible for identifying characteristics of the data to be accessed from data publisher endpoints, such as the data publisher endpoint device 105, specifying conditions governing the data to be accessed, subscribing to receive data availability notifications from the data exchange 115, requesting a transaction to obtain access to data being provided by a data publisher endpoint, such as the data publisher endpoint device 105, etc. Implementation and operation of the datamart subscriber client 160 of the illustrated example is described in further detail below and in connection with FIG. 3.

As noted above, the digital data exchange system 100 is built upon the example blockchain network 120, which implements a blockchain. As such, the blockchain client 140B is included in the data subscriber endpoint system 110 of the illustrated example to publish data transaction records to the blockchain implemented by the blockchain network 120, with the data transaction records being associated with data being accessed by the data subscriber endpoint system 110. Implementation and operation of the blockchain client 140B of the illustrated example is described in further detail below and in connection with FIG. 4.

In the illustrated example of FIG. 1, the data subscriber endpoint system 110 also includes the smart contract application 165 to validate a transaction to obtain access to data from a data publisher endpoint, such as the data publisher endpoint device 105. For example, the datamart subscriber client 160 may program the smart contract application 165 with one or more conditions governing the data to be accessed, such as a quantity of data to be accessed, a duration of time covered by the data, etc. In such an example, after a data transaction has been initiated by the data publisher endpoint device 105 in response to a request from the datamart subscriber client 160, the smart contract application 165 verifies whether the relevant condition(s) governing the data have been met. For example, the smart contract application 165 may be programmed to perform an initial access of the data stored in the storage device of the data publisher endpoint device 105 to determine the data meets the relevant condition(s). If the smart contract application 165 confirms the relevant condition(s) have been met, the smart contract application 165 validates the transaction, causes the datamart subscriber client 160 to accept the transaction (e.g., by sending a message to the data publisher endpoint device 105) and causes the blockchain client 140B to publish a record of the transaction to the blockchain network 120. Otherwise, the smart contract application 165 causes the transaction to be terminated. Furthermore, in some examples, if one or more of the relevant condition(s) have not been met, the smart contract application 165 is programmed to treat such an event as a contract breach and enforce a penalty condition. For example, the smart contract application 165 can be programmed to interface with a payment service to cause an appropriate payment or credit to be made to compensate for the contract breach.

In some examples, the smart contract application 145 is programmed by the datamart subscriber client 160 to interface with and continue to monitor access of data, which is the subject of a validated transaction, by a data consumer application 127 after the transaction has been validated to enforce the relevant condition(s) governing access to the data by the data consumer application 127 of the data subscriber endpoint system 110. For example, the smart contract application 165 may be programmed with conditions governing the frequency with which the data is permitted to be accessed, the amount of data that is permitted to be accessed, the duration of time during which the data is permitted to be accessed, etc. For example, if the data subscriber endpoint system 110 has agreed to lease data made available by the data publisher endpoint device 105 (e.g., stored in the data storage 130), the smart contract application 165 may be programmed to monitor whether an expiration time of the lease has elapsed. When the expiration time has elapsed, the smart contract application 165 causes the associated data to be deleted from the data storage 170 of the data subscriber endpoint system 110. In some examples, if the smart contract application 165 determines one or more of the relevant conditions have been breached after the transaction has been validated, the smart contract application 165 can enforce a penalty condition, as described above.

In some examples, the smart contract application 165 is programmed to monitor data, which is the subject of an initiated or validated transaction, to enforce relevant condition(s) to be met by the data publisher endpoint device 105. Such condition(s) can be specified by the data publisher endpoint device 105 when publishing the availability of the data, and/or by the data subscriber endpoint system 110 when requesting initiation of the transaction and/or accepting the transaction. For example, if the data that is the subject of the transaction is collected in real-time by the data publisher endpoint device 105, the smart contract application 165 may be programmed to monitor the data to ensure it is consistent with the relevant condition(s) governing data collection. If, for example, one or more of the relevant condition(s) are not met, such as the data not being associated an agreed-upon generation time, not exhibiting an agreed-upon update frequency or otherwise not in accordance with agreed-upon procedures, the smart contract application 165 can detect this breach of the relevant condition(s) and enforce a penalty condition, as described above.

In the illustrated example of FIG. 1, the data exchange 115 implements a data publication, subscription and notification service to enable data publishers, such as the data publisher endpoint device 105, to publish the availability of data, and to enable data subscribers, such the data subscriber endpoint system 110. to subscribe to and receive data availability notifications indicating that data is available from data publishers, such as the data publisher endpoint device 105. For example, the data exchange 115 can implement a bulletin board service, a torrent service, a directory service, etc., to provide such data publication, subscription and notification. As such, the data exchange 115 can be implemented by any suitably configured, adapted or otherwise structured computing device (e.g., a smartphone, a tablet computer, a notebook computer, a desktop computer, a smart appliance, etc.), server, data center, cloud service, etc.

The communication network 125 of the illustrated example can be implemented by any number and/or types of communication networks. For example, the communication network 125 can be implemented by one or more wired/cabled networks, one or more wireless networks (e.g., mobile cellular networks, satellite networks, etc.), one or more proprietary networks, one or more public networks (e.g., such as the Internet), etc., or any combination thereof.

Although the example blockchain-based digital data exchange system 100 of FIG. 1 is illustrated as including one example data publisher endpoint device 105, one example data subscriber endpoint system 110, one example data exchange 115, one example blockchain network 120 and one example communication network 125, blockchain-based digital data exchanges implemented in accordance with teachings of this disclosure are not limited thereto. On the contrary, example blockchain-based digital data exchange systems 100 can include any number of example data publisher endpoint devices 105, example data subscriber endpoint systems 110, example data exchanges 115, example blockchain networks 120 and/or example communication networks 125.

A block diagram of an example implementation of the datamart publisher client 135 included in the example data publisher endpoint device 105 of FIG. 1 is illustrated in FIG. 2. The example datamart publisher client 135 includes an example data labeler 205, an example data availability publisher 210, an example data validator 215, an example transaction authorizer 220 and an example data provider 225. The datamart publisher client 135 of FIG. 2 includes the example data labeler 205 to identify and label the data to be made accessible by the data publisher endpoint device 105 to data subscribers, such as the data subscriber endpoint system 110. In some examples, the data labeler 205 implements a graphical user interface (GUI) to permit the data to be identified. For example, the data labeler 205 may provide an interface to select one or more of the data producing application(s) 150 to be sources of data to be made accessible by the data publisher endpoint device 105. Additionally or alternatively, the data labeler 205 may provide an interface to select data in the data storage 130 (e.g., by drive, directory, filename, etc.) to be made accessible by the data publisher endpoint device 105. The data labeler 205 of the illustrated example also generates a label to identify the data to be made accessible by the data publisher endpoint device 105. For example, the data labeler 205 may process some or all of the identified data with a hash function to generate a hash of the identified data, which may form the basis of the label to be used to identify the data. In some examples, the label generated by the data labeler 205 for the identified data includes multiple fields, such as an identifier field and one or more fields to describe the data. For example, the data labeler 205 can include a field containing an identifier of the data (e.g., such as the hash of the data), one or more fields containing one or more properties of the data (e.g., such as the type of data, for example, heart rate data, log data, etc.), one or more fields containing metadata associated with the data (e.g., such as a gender associated with the heart rate data, a person's age associated with the heart rate data, etc.), etc. In some examples, the data labeler 205 obtains the properties of the data, the metadata associated with the data, etc., from one or more of the data producing application(s) 150 responsible for generating and/or collecting the data.

The datamart publisher client 135 of FIG. 2 includes the example data availability publisher 210 to publish the availability of the data identified by the data labeler 205. In some examples, the data availability publisher 210 transmits a message to the data exchange 115 to inform the data exchange 115 that the data publisher endpoint device 105 has data to be made available to data subscribers, such as the data subscriber endpoint system 110. The message may include the label (e.g., hash) generated by the data labeler 205 for the data, as well as any condition(s) to govern access to the data. In some examples, the data availability publisher 210 implements a GUI to permit such condition(s) to be specified. For example, the GUI of the data availability publisher 210 may permit specification of a price for accessing the data, whether the data is being offered for sale or lease, a lease duration if the data is being offered for sale, a permitted access frequency, an amount of data permitted to be accessed, etc. In some examples, the message may include one or more condition(s) that govern characteristics of the data. In some such examples, the data availability publisher 210 implements a GUI to permit such condition(s) to be specified. For example, the GUI of the data availability publisher 210 may permit specification of an update frequency associated with the data, a guaranteed minimum amount of data, a duration of time covered by the data, etc.

The datamart publisher client 135 of FIG. 2 includes the example transaction authorizer 220 to authorize a transaction to permit a data subscriber, such as the data subscriber endpoint system 110, to access the data being made available by the data publisher endpoint device 105. In some examples, the transaction authorizer 220 receives a request from a data subscriber, such as the data subscriber endpoint system 110, to initiate a transaction to permit access to data identified by a label published by the data availability publisher 210. In some examples, in response to the request, the data provider 225 of the datamart publisher client 135 provides the data subscriber endpoint system 110 with initial access to the data identified by the label. This initial access to the data enables the data subscriber endpoint system 110 to verify the suitability of the data (e.g., by comparing the data to one or more criteria). Subsequently, in some such examples, the transaction authorizer 220 may receive a message from the data subscriber endpoint system 110 accepting the transaction. If an acceptance message is not received, the transaction authorizer 220 causes the data provider 225 to block the data subscriber endpoint system 110 from having further access to the data. However, if an acceptance message is received, the transaction authorizer 220 interfaces with the smart contract application 145 of the data publisher endpoint device 105 to verify the relevant condition(s) for accessing the data have been met (e.g., such as verifying that the specified price for accessing the data has been paid). If the relevant condition(s) have not been met, the transaction authorizer 220 cancels the transaction. However, if the relevant condition(s) have been met, the transaction authorizer 220 causes the data provider 225 to permit the data subscriber endpoint system 110 to continue to access the data, and causes the blockchain client 140A of the data publisher endpoint device 105 to publish a record of the transaction to the blockchain network 120, which is to be added to the blockchain implemented by the blockchain network 120.

In some examples, the record published by the transaction authorizer 220 includes the label (e.g., hash) identifying the data, the price for accessing the data, an identifier associated with the data publisher endpoint device 105 and an identifier associated with the data subscriber endpoint system 110. In some examples, the record also includes a transaction type specifying the permitted type(s) of data access permitted by the transaction. Examples of transaction types include, but are not limited to, data read access, data write access, data processing access (e.g., read and write), etc.

In some examples, the data provider 225 implements data encryption to provide a particular data subscriber, such as the data subscriber endpoint system 110, with access to specific data. For example, the transaction initiation request from the data subscriber endpoint system 110 may include a public encryption key associated with the data subscriber endpoint system 110. In such examples, the data provider 225 can encrypt the specific data to be made accessible to the data subscriber endpoint system 110 with the public encryption key provided by the data subscriber endpoint system 110. The data subscriber endpoint system 110 can then decrypt the data with the private encryption key associated with its public encryption key. In some such examples, if the data provider 225 is to later block access to the data by the data subscriber endpoint system 110, the data provider 225 can use a different key to encrypt the data, which is not paired with the private encryption key of the data subscriber endpoint system 110. By using encryption in this manner, the data publisher endpoint device 105 can restrict data access to only intended recipient(s) by creating different versions (e.g., copies) of the data that are encrypted with the respective public encryption key(s) associated with the intended recipient(s).

In some examples, the transaction authorizer 220 operates with the data validator 215 of the datamart publisher client 135 to enforce relevant condition(s) governing characteristics of the data and/or access to the data after the transaction has been validated. For example, the data validator 215 can program the smart contract application 145 with condition(s) to be monitored while a transaction for given identified data is active. For example, the data validator 215 may program the smart contract application 145 with conditions governing the frequency with which the identified data is to be accessed, the amount of identified data that is to be accessed, the duration of time during which the identified data is permitted to be accessed, etc. If the data validator 215 determines that one or more of the specified condition(s) has not been met, the transaction authorizer 220 can update the transaction accordingly. For example, the transaction authorizer 220 may terminate the transaction, place the transaction on hold, etc. In some such examples, the transaction authorizer 220 publishes a record updating the transaction to the blockchain network 120, which is to be added to the blockchain implemented by the blockchain network 120. For example, the record may include the label (e.g., hash) identifying the data, the price for accessing the data, the identifier associated with the data publisher endpoint device 105, the identifier associated with the data subscriber endpoint system 110 and a transaction type set to terminated, on-hold, etc.

A block diagram of an example implementation of the datamart subscriber client 160 included in the example data subscriber endpoint system 110 of FIG. 1 is illustrated in FIG. 3. The example datamart subscriber client 160 of FIG. 3 includes an example data retriever 305, an example data availability subscriber 310, an example transaction authorizer 315, an example data validator 320 and an example access validator 325. The datamart subscriber client 160 of FIG. 3 includes the example data availability subscriber 310 to subscribe to and received data availability notifications from the data exchange 115. In some examples, the data availability subscriber 310 sends a subscription request to the data exchange 115 to subscribe to notifications that are generated when data providers, such as the data publisher endpoint device 105, publish the availability of data with the data exchange 115. In some such examples, the subscription request includes one or more criteria (e.g., specified via a GUI implemented by the data availability subscriber 310) to be used by the data exchange 115 to filter the data availability notifications. Such filtering can be used by the data exchange 115 to limit/restrict the data availability notification sent to the data subscriber endpoint system 110 to those notifications that match the criteria specified in the subscription request. In some examples, a data availability notification received by the data availability subscriber 310 from the data exchange 115 include a label (e.g., hash) identifying the data being made available, as well as any condition(s) governing characteristics of the data and/or access to the data (e.g., a price for accessing the data, whether the data is being offered for sale or lease, a lease duration if the data is being offered for sale, a permitted access frequency, an amount of data permitted to be accessed, etc.).

The datamart subscriber client 160 of FIG. 3 includes the transaction authorizer 315 to authorize a transaction to permit the data subscriber endpoint system 110 to access data identified in a notification received from the data exchange 115. In some examples, the transaction authorizer 315 compares information from the notification that describes the data being offered with target characteristics of data the data subscriber endpoint system 110 wishes to access to determine whether the data identified in the notification matches the characteristics. For example, the target characteristics may specify a type of data (e.g., health data, log data, etc.), a duration of time covered by the data, and amount of the data, a format of the data, acceptable conditions governing access to the data, etc. In some examples, the transaction authorizer 315 implements a GUI to permit specification of the target characteristics of the data the data subscriber endpoint system 110 wishes to access.

If the target characteristics specified for the data the data subscriber endpoint system 110 wishes to access match the information included in the notification from the data exchange 115, the transaction authorizer 315 transmits a request including the data label contained in the notification to the data publisher identified in the notification, such as the data publisher endpoint device 105, to initiate a transaction to allow the data subscriber endpoint system 110 to gain access to the offered data. In some examples, the request includes a public key associated with the data subscriber endpoint system 110, which is to be used by the data publisher endpoint device 105 to encrypt the data to that is to be provided to the data subscriber endpoint system 110. In some examples, the transaction initiation request sent by the transaction authorizer 315 includes one or more conditions specified by the data subscriber endpoint system 110 and that are to be met by the data provided by the data publisher endpoint device 105. For example, such conditions may govern collection of the data and may specify a required data generation time, a required update frequency, etc. In some examples, the transaction authorizer 315 implements a GUI to permit specification of the conditions to be met by the data provided by the data publisher endpoint device 105.

In some examples, the transaction authorizer 315 operates with the data retriever 305 of the datamart subscriber client 160 to perform an initial validation of the data being provided by the data publisher endpoint device 105 before accepting the data transaction. For example, in response to a request to initiate a data transaction, the data publisher endpoint device 105 may initiate the transaction by providing the data subscriber endpoint system 110 with initial access to the offered data. In such an example, the data retriever 305 retrieves the offered data from the data publisher endpoint device 105 and decrypts the data with the private encryption key associated with the public encryption key included in the request that was transmitted by the transaction authorizer 315 to request initiation the data transaction. The transaction authorizer 315 then interfaces with the smart contract application 165 of the data subscriber endpoint system 110 to verify the relevant condition(s) specified for the data (e.g., as specified in the notification received from the data exchange 115 and/or in the transaction initiation request sent by the transaction authorizer 315) are met. If one or more of the conditions are not met, the transaction authorizer 315 cancels the transaction. However, if the relevant condition(s) have been met, the transaction authorizer 315 transmits a message to the data publisher endpoint device 105 to accept the transaction and, in some examples, causes the blockchain client 140B of the data subscriber endpoint system 110 to publish a record of the transaction to the blockchain network 120, which is to be added to the blockchain implemented by the blockchain network 120. Characteristics of the record published by the blockchain client 140B are described above in connection with FIG. 2. Assuming the transaction is also authorized by the data publisher endpoint device 105, the data retriever 305 can then continue to access the data made available by the data publisher endpoint device 105.

In some examples, the transaction authorizer 315 operates with the data validator 320 and/or the access validator 325 of the datamart subscriber client 160 to enforce relevant condition(s) governing the data and/or access to the data after the transaction has been validated. For example, the data validator 320 can program the smart contract application 165 with data characteristic condition(s) to be monitored while a transaction for given data is active. For example, the data validator 320 may program the smart contract application 165 with condition governing the collection of the data by the data publisher endpoint device 105, as described above. In some examples, the access validator 325 can program the smart contract application 165 with data access condition(s) to be monitored while a transaction for given identified data is active. For example, the access validator 325 may program the smart contract application 165 with conditions governing the frequency with which the data retriever 305 is permitted to access the data made available by the data publisher endpoint device 105, the amount data the data retriever 305 is permitted to access, the duration of time during which the data retriever 305 is permitted to access data, etc. If the data validator 320 and/or the access validator 325 determines that one or more of the specified condition(s) have not been met, the transaction authorizer 315 can update the transaction accordingly. For example, the transaction authorizer 315 may terminate the transaction, place the transaction on hold, etc. In some such examples, the transaction authorizer 315 publishes a record updating the transaction to the blockchain network 120, which is to be added to the blockchain implemented by the blockchain network 120. For example, the record may include the label (e.g., hash) identifying the data, the price for accessing the data, the identifier associated with the data publisher endpoint device 105, the identifier associated with the data subscriber endpoint system 110 and a transaction type set to terminated, on-hold, etc.

A block diagram of an example blockchain client 140 that may be used to implement the blockchain client 140A included in the example data publisher endpoint device 105 and/or the blockchain client 140B included in the example data subscriber endpoint system 110 of FIG. 1 is illustrated in FIG. 4. The example blockchain client 140 of FIG. 4 includes an example transaction publisher 405 and an example transaction auditor 410. The blockchain client 140 includes the transaction publisher 405 to publish records of data transaction to the blockchain network 120, which are to be added to a blockchain implemented by the blockchain network 120. For example, to publish a record, the transaction publisher 405 can transmit a request containing the record to one or more of the computing nodes 155A-E implementing the blockchain network 120. In response to the request, one or more of the computing nodes 155A-E will include the record in a block of records and attempt to add the block to the blockchain in accordance with the blockchain technology implemented by the blockchain network 120. In some examples, a given record to be published by the transaction publisher 405 includes a label (e.g., hash) identifying the data that is the subject of the transaction, the price for accessing the data, an identifier associated with the data publisher endpoint device 105 that is to provide the data and an identifier associated with the data subscriber endpoint system 110 that is to access the data. In some examples, the record also includes a transaction type specifying the permitted type(s) of data access permitted by the transaction. Examples of transaction types include, but are not limited to, data read access, data write access, data processing access (e.g., read and write), etc.

The blockchain client 140 includes the transaction auditor 410 to audit the records contained in the blockchain implemented by the blockchain network 120. Because the records contained in the blockchain include labels (e.g., hashes) identifying the data that is the subject of each record, the transaction auditor 410 can examine the blockchain to identify records associated with specific data of interest. If a record associated with the specific data of interest is found, the transaction auditor 410 can further examine the contents of the record, such as the identifier of the data publisher endpoint device 105 included in the record, the identifier of the data subscriber endpoint system 110, etc., to determine whether the data transaction associated with the record was proper or improper. If the data transaction was improper, the transaction auditor 410 can notify its associated datamart client (e.g., the datamart publisher client 135 or the datamart subscriber client 160) of the improper data transaction to enable the datamart client to take appropriate remedial action (e.g., such as presenting a message at the associated endpoint, sending a message to a user device, enforcing a monetary penalty on one or more of the endpoints associated with the improper transaction, etc.).

For example, consider a scenario in which a first data subscriber endpoint system 110 improperly copied data accessed from a data publisher endpoint device 105 and makes the copied data available to a second data subscriber endpoint system 110 in the digital data exchange system 100 (e.g., by selling the copied data, leasing the copied data, etc.). A record of this improper transaction would be added to the blockchain implemented by the blockchain network 120 in the manner described above. The record would include the label (e.g., hash) identifying the data, and would also identify the first data subscriber endpoint system 110 as the data provider in this transaction, and would identify the second data subscriber endpoint system 110 as the data subscriber of this transaction. In such an example, the transaction auditor 410 could identify the specific data that was the subject of this transaction based on the label (e.g., hash) included in the record, and could determine the transaction was improper because the record identifies the first data subscriber endpoint system 110 as the data provider in the transaction, but the first data subscriber endpoint system 110 was not authorized to copy and share the data with another data subscriber.

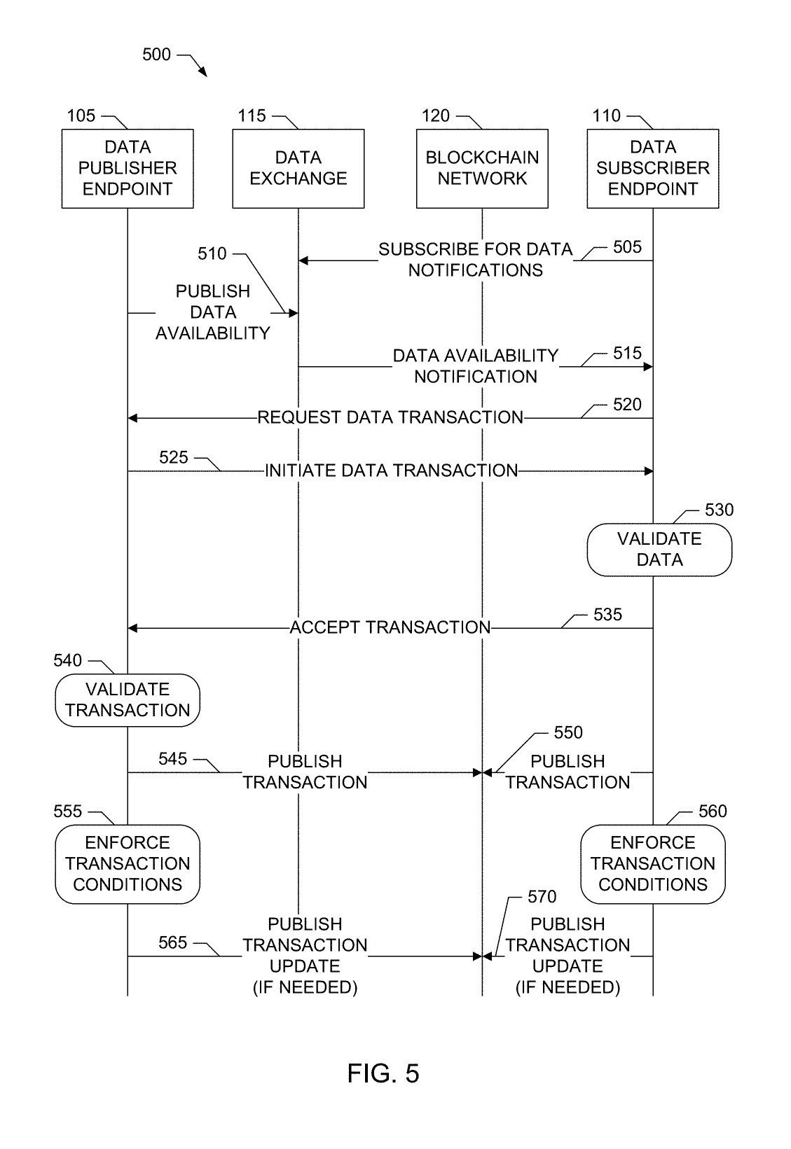

An example message sequence diagram 500 illustrating example operation of the of the blockchain-based digital data exchange system 100 of FIG. 1 is illustrated in FIG. 5. The message sequence diagram 500 of the illustrated example begins with the data subscriber endpoint system 110 transmitting an example subscription request 505 to the data exchange 115 to subscribe to notifications that are generated when data providers, such as the data publisher endpoint device 105, publish the availability of data with the data exchange 115. In the illustrated example, the data publisher endpoint device 105 transmits an example publish data availability message 510 to the data exchange 115 to inform the data exchange 115 that the data publisher endpoint device 105 has data to be made available to data subscribers, such as the data subscriber endpoint system 110. In the illustrated example, the publish data availability message 510 includes a label (e.g., hash) identifying the data, one or more characteristics of the data, and one or more condition for accessing the data. In response to the publish data availability message 510, the data exchange 115 transmits an example data availability notification 515 to the data subscriber endpoint system 110 identifying the data that is being offered by the data publisher endpoint device 105. In the illustrated example, the data availability notification 515 includes the label (e.g., hash) identifying the data, the one or more characteristics of the data and the one or more condition for accessing the data as specified in the publish data availability message 510, as well as an identifier of the data publisher endpoint device 105.

Assuming the data identified in the data availability notification 515 is of interest to the data subscriber endpoint system 110, the data subscriber endpoint system 110 transmits an example data transaction request 520 to the data publisher endpoint device 105 identified in the data availability notification 515. In the illustrated example, the data transaction request 520 includes the label (e.g., hash) identifying the data as specified in the data availability notification 515, and a public encryption key associated with the data subscriber endpoint system 110. In the illustrated example, in response to the data transaction request 520, the data publisher endpoint device 105 transmits an example data transaction initiation message 525 to the data subscriber endpoint system 110. In the illustrated example, the data transaction initiation message 525 specifies a location (e.g., a network address, a uniform resource locator (URL), etc.) at which the data subscriber endpoint system 110 can access the data identified by the label (e.g., hash) included in the data transaction request 520. In the illustrated example, the data subscriber endpoint system 110 accesses the data, decrypts the data using the private encryption key associated with the public encryption key included in the data transaction request 520, and validates the data as described above (which is represented by block 530 in FIG. 5). Assuming the data is validated, the data subscriber endpoint system 110 transmits an example accept transaction message 535 to the data publisher endpoint device 105.

In the illustrated example, in response to the accept transaction message 535, the data publisher endpoint device 105 also validates the transaction (e.g., by confirming a specified payment for accessing the data has been paid), as described above (which is represented by block 530 in FIG. 5). In the illustrated example, assuming the transaction is authorized, the data publisher endpoint device 105 transmits an example publish transaction message 545 containing a record of the transaction to the blockchain network 120. In some examples, after validating the data associated with the transaction, the data subscriber endpoint system 110 also transmits an example publish transaction message 550 containing a record of the transaction to the blockchain network 120. Example contents of such a record are described above.

In the illustrated example, the data publisher endpoint device 105 and the data subscriber endpoint system 110 continue to monitor, as described above, the data being provided by the data publisher endpoint device 105 and/or the data access operations being performed by the data subscriber endpoint system 110 to enforce the condition(s) specified for the transaction (which is represented by blocks 555 and 560 in FIG. 5). If one or more of the conditions are not met, the data publisher endpoint device 105 transmits an example publish transaction message 565 to the blockchain network 120 and/or the data subscriber endpoint system 110 transmits an example publish transaction message 570 to the blockchain network 120 to update the transaction (e.g., to cancel the transaction, place the transaction on-hold, etc.).

While example manners of implementing the example data publisher endpoint device 105 and the example data subscriber endpoint system 110 are illustrated in FIGS. 1-5, one or more of the elements, processes and/or devices illustrated in FIGS. 1-5 may be combined, divided, re-arranged, omitted, eliminated and/or implemented in any other way. Further, the example data storage 130 and/or 170, the example datamart publisher client 135, the example blockchain clients 140, 140A and/or 140B, the example smart contract applications 145 and/or 165, the example datamart subscriber client 160, the example data labeler 205, the example data availability publisher 210, the example data validator 215, the example transaction authorizer 220, the example data provider 225, the example data retriever 305, the example data availability subscriber 310, the example transaction authorizer 315, the example data validator 320, the example access validator 325, the example transaction publisher 405, the example transaction auditor 410 and/or, more generally, the example data publisher endpoint device 105 and/or the example data subscriber endpoint system 110 may be implemented by hardware, software, firmware and/or any combination of hardware, software and/or firmware. Thus, for example, any of the example data storage 130 and/or 170, the example datamart publisher client 135, the example blockchain clients 140, 140A and/or 140B, the example smart contract applications 145 and/or 165, the example datamart subscriber client 160, the example data labeler 205, the example data availability publisher 210, the example data validator 215, the example transaction authorizer 220, the example data provider 225, the example data retriever 305, the example data availability subscriber 310, the example transaction authorizer 315, the example data validator 320, the example access validator 325, the example transaction publisher 405, the example transaction auditor 410 and/or, more generally, the example data publisher endpoint device 105 and/or the example data subscriber endpoint system 110 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)), field programmable gate arrays (FPGAs) and/or field programmable logic device(s) (FPLD(s)). When reading any of the apparatus or system claims of this patent to cover a purely software and/or firmware implementation, at least one of the example data publisher endpoint device 105, the example data subscriber endpoint system 110, the example data storage 130 and/or 170, the example datamart publisher client 135, the example blockchain clients 140, 140A and/or 140B, the example smart contract applications 145 and/or 165, the example datamart subscriber client 160, the example data labeler 205, the example data availability publisher 210, the example data validator 215, the example transaction authorizer 220, the example data provider 225, the example data retriever 305, the example data availability subscriber 310, the example transaction authorizer 315, the example data validator 320, the example access validator 325, the example transaction publisher 405 and/or the example transaction auditor 410 is/are hereby expressly defined to include a non-transitory computer readable storage device or storage disk such as a memory, a digital versatile disk (DVD), a compact disk (CD), a Blu-ray disk, etc. including the software and/or firmware. Further still, the example data publisher endpoint device 105 and/or the example data subscriber endpoint system 110 may include one or more elements, processes and/or devices in addition to, or instead of, those illustrated in FIGS. 1-5, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

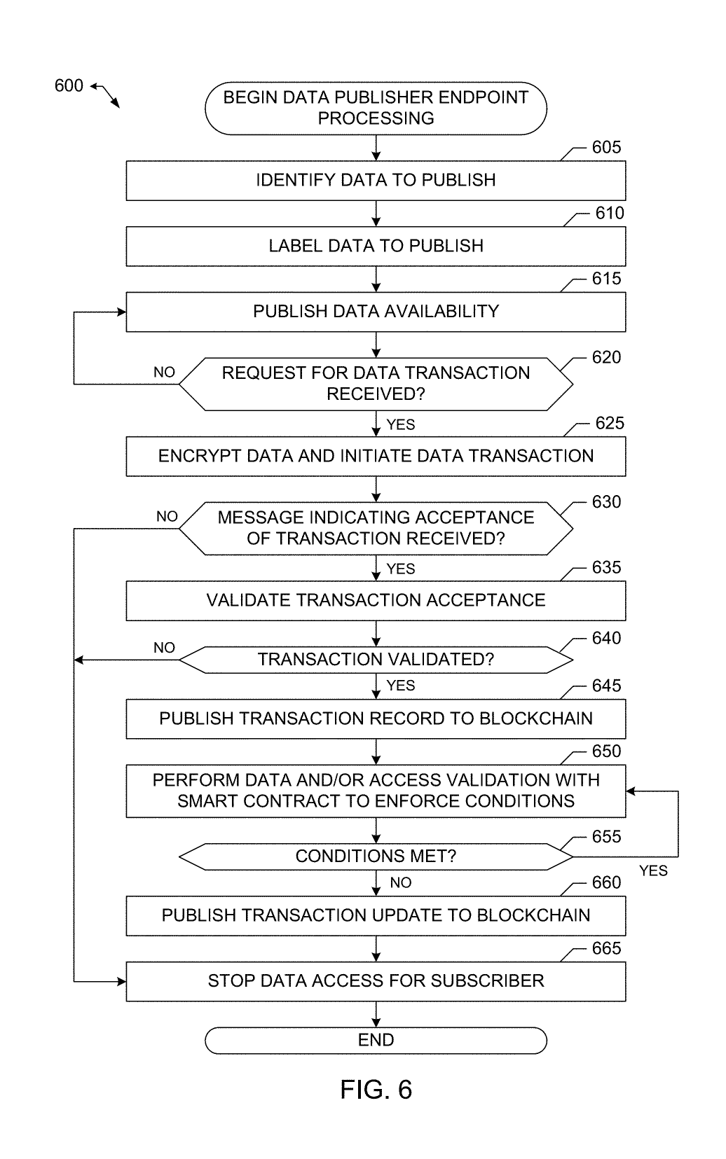

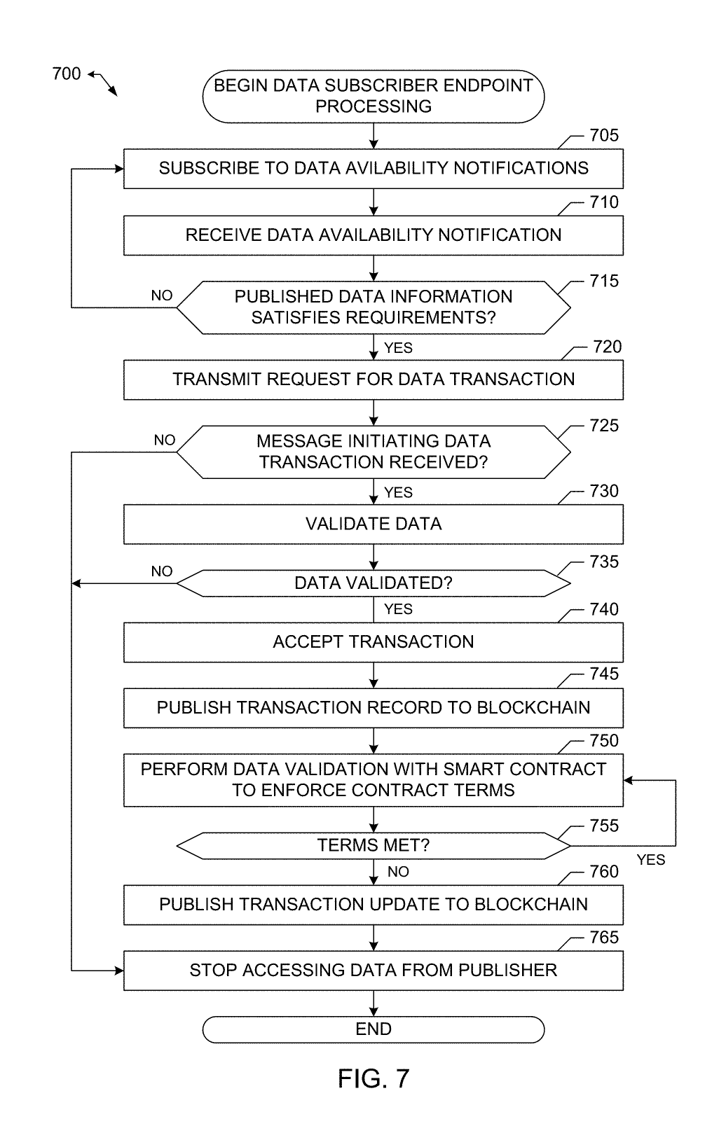

Flowcharts representative of example hardware logic, machine readable instructions, hardware implemented state machines, and/or any combination thereof for implementing the example data publisher endpoint device 105 and the example data subscriber endpoint system 110 are shown in FIGS. 6-7. In these examples, the machine readable instructions may be one or more executable programs or portion(s) thereof for execution by a computer processor, such as the processor 812 and/or 912 shown in the example processor platform 800 and 900 discussed below in connection with FIGS. 8 and 9. The one or more programs, or portion(s) thereof, may be embodied in software stored on a non-transitory computer readable storage medium such as a CD-ROM, a floppy disk, a hard drive, a DVD, a Blu-ray Disk™, or a memory associated with the processor 812 and/or 912, but the entire program or programs and/or parts thereof could alternatively be executed by a device other than the processor 812 and/or 912, and/or embodied in firmware or dedicated hardware. Further, although the example program(s) is(are) described with reference to the flowcharts illustrated in FIGS. 6-7, many other methods of implementing the example data publisher endpoint device 105 and the example data subscriber endpoint system 110 may alternatively be used. For example, with reference to the flowcharts illustrated in FIGS. 6-7, the order of execution of the blocks may be changed, and/or some of the blocks described may be changed, eliminated, combined and/or subdivided into multiple blocks. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example processes of FIGS. 6-7 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. Also, as used herein, the terms “computer readable” and “machine readable” are considered equivalent unless indicated otherwise.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

An example program 600 that may be executed to implement the example data publisher endpoint device 105 of FIGS. 1-5 is represented by the flowchart shown in FIG. 6. With reference to the preceding figures and associated written descriptions, the example program 600 of FIG. 6 begins execution at block 605 at which the data publisher endpoint device 105 identifies data to be made available, as described above. At block 610, the data publisher endpoint device 105 determines a label for the data, which may be based on a hash of the data, as described above. At block 615, the data publisher endpoint device 105 publishes the availability of the data to the data exchange 115, as described above. At block 620, the data publisher endpoint device 105 monitors for a request from a data subscriber, such as the data subscriber endpoint system 110, to initiate a transaction to access the published data.

If a request to initiate a data transaction is received (block 620), at block 625 the data publisher endpoint device 105 encrypts the data identified in the transaction initiation request with a public encryption key included in the transaction initiation request, as described above. At block 625, the data publisher endpoint device 105 also initiates the data transaction by providing the requesting data subscriber endpoint system 110 with initial access to the identified data, as described above. At block 630, the data publisher endpoint device 105 monitors for a message from the requesting data subscriber endpoint system 110 indicating acceptance of the transaction.

If the data transaction is accepted (block 630), at block 635 the data publisher endpoint device 105 validates the acceptance of the transaction (e.g., by confirming the specified payment for accessing the data has been made by the requesting data subscriber endpoint system 110), as described above. If the transaction is validated (block 640), at block 645 the data publisher endpoint device 105 publishes a record of the transaction to the blockchain network 120, as described above. At block 650, the data publisher endpoint device 105 continues to validate any relevant data collection condition(s), data access condition(s), etc., specified for the transaction, as described above. If one or more of the conditions are not met (block 655), the data publisher endpoint device 105 publishes a record updating the transaction to the blockchain network 120, as described above. At block 665, the data publisher endpoint device 105 stops the requesting data subscriber endpoint system 110 from being able to access the data, as described above.

An example program 700 that may be executed to implement the example data subscriber endpoint system 110 of FIGS. 1-5 is represented by the flowchart shown in FIG. 7. With reference to the preceding figures and associated written descriptions, the example program 700 of FIG. 7 begins execution at block 705 at which the data subscriber endpoint system 110 subscribes with the data exchange 115 for data availability notifications, as described above. At block 710, the data subscriber endpoint system 110 receives a data availability notification from the data exchange 115 including a label (e.g., hash) identifying data that is being made available (offered) by a data publisher identified in the notification, such as the data publisher endpoint device 105, as described above. If the data identified in the data availability notification satisfies one or more criteria (block 715), at block 720 the data subscriber endpoint system 110 transmits a request to the data publisher endpoint device 105 to initiate a data transaction for the identified data, as described above. In the illustrated example, the transaction initiation request includes the label (e.g., hash) identifying the data and a public encryption key associated with the data subscriber endpoint system 110.

If a response message initiation the data transaction is received in response to the transaction initiation request (block 725), at block 730 the data subscriber endpoint system 110, as described above. For example, at block 730 the data subscriber endpoint system 110 may access the data at a location specified in the received transaction initiation message, decrypt the data using a private encryption key associated with the public encryption key included in the transaction initiation request, and validate the data against one or more conditions, as described above.

If the data is validated (block 735), at block 740 the data subscriber endpoint system 110 transmits a message to the data publisher endpoint device 105 to accept the transaction, as described above. At block 745, the data subscriber endpoint system 110 publishes a record of the transaction to the blockchain network 120, as described above. At block 750, the data subscriber endpoint system 110 continues to validate any relevant data collection condition(s), data access condition(s), etc., specified for the transaction, as described above. If one or more of the conditions are not met (block 755), the data subscriber endpoint system 110 publishes a record updating the transaction to the blockchain network 120, as described above. At block 765, the data subscriber endpoint system 110 stops accessing the data from the data publisher endpoint device 105, as described above

FIG. 8 is a block diagram of an example processor platform 800 structured to execute the instructions of FIG. 6 to implement the example data publisher endpoint device 105 of FIGS. 1-5. The processor platform 800 can be, for example, a server, a personal computer, a workstation, a self-learning machine (e.g., a neural network), a mobile device (e.g., a cell phone, a smart phone, a tablet such as an iPad′), a personal digital assistant (PDA), an Internet appliance, a gaming console, a set top box or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor 812 may be a semiconductor based (e.g., silicon based) device. In this example, the processor 812 implements the example datamart publisher client 135, the example blockchain client 140A, the example smart contract applications 145, the example data labeler 205, the example data availability publisher 210, the example data validator 215, the example transaction authorizer 220, the example data provider 225, the example transaction publisher 405 and/or the example transaction auditor 410.

The processor 812 of the illustrated example includes a local memory 813 (e.g., a cache). The processor 812 of the illustrated example is in communication with a main memory including a volatile memory 814 and a non-volatile memory 816 via a link 818. The link 818 may be implemented by a bus, one or more point-to-point connections, etc., or a combination thereof. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuit 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 800, can allow the user to control the computer system and provide data to the computer using physical gestures, such as, but not limited to, hand or body movements, facial expressions, and face recognition.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speakers(s). The interface circuit 820 of the illustrated example, thus, typically includes a graphics driver card, a graphics driver chip and/or a graphics driver processor.

The interface circuit 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives. In some examples, the mass storage device(s) 828 may implement the data storage 130. Additionally or alternatively, in some examples the volatile memory 814 may implement the data storage 130.

The machine executable instructions 832 corresponding to the instructions of FIG. 6 may be stored in the mass storage device 828, in the volatile memory 814, in the non-volatile memory 816, in the local memory 813 and/or on a removable non-transitory computer readable storage medium, such as a CD or DVD 836.

FIG. 9 is a block diagram of an example processor platform 900 structured to execute the instructions of FIG. 7 to implement the example data subscriber endpoint system 110 of FIGS. 1-5. The processor platform 900 can be, for example, a server, a personal computer, a workstation, a self-learning machine (e.g., a neural network), a mobile device (e.g., a cell phone, a smart phone, a tablet such as an iPad), a PDA, an Internet appliance, a gaming console, a set top box or any other type of computing device.

The processor platform 900 of the illustrated example includes a processor 912. The processor 912 of the illustrated example is hardware. For example, the processor 912 can be implemented by one or more integrated circuits, logic circuits, microprocessors, GPUs, DSPs, or controllers from any desired family or manufacturer. The hardware processor 912 may be a semiconductor based (e.g., silicon based) device. In this example, the processor 912 implements the example blockchain client 140B, the example datamart subscriber client 160, the example smart contract application 165, the example data retriever 305, the example data availability subscriber 310, the example transaction authorizer 315, the example data validator 320, the example access validator 325, the example transaction publisher 405 and/or the example transaction auditor 410.

The processor 912 of the illustrated example includes a local memory 913 (e.g., a cache). The processor 912 of the illustrated example is in communication with a main memory including a volatile memory 914 and a non-volatile memory 916 via a link 918. The link 918 may be implemented by a bus, one or more point-to-point connections, etc., or a combination thereof. The volatile memory 914 may be implemented by SDRAM, DRAM, RAMBUS® RDRAM® and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a USB, a Bluetooth® interface, an NFC interface, and/or a PCI express interface.

In the illustrated example, one or more input devices 922 are connected to the interface circuit 920. The input device(s) 922 permit(s) a user to enter data and/or commands into the processor 912. The input device(s) can be implemented by, for example, an audio sensor, a microphone, a camera (still or video), a keyboard, a button, a mouse, a touchscreen, a track-pad, a trackball, a trackbar (such as an isopoint), a voice recognition system and/or any other human-machine interface. Also, many systems, such as the processor platform 900, can allow the user to control the computer system and provide data to the computer using physical gestures, such as, but not limited to, hand or body movements, facial expressions, and face recognition.

One or more output devices 924 are also connected to the interface circuit 920 of the illustrated example. The output devices 924 can be implemented, for example, by display devices (e.g., an LED, an OLED, an LCD, a CRT display, an IPS display, a touchscreen, etc.), a tactile output device, a printer and/or speakers(s). The interface circuit 920 of the illustrated example, thus, typically includes a graphics driver card, a graphics driver chip and/or a graphics driver processor.

The interface circuit 920 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 926. The communication can be via, for example, an Ethernet connection, a DSL connection, a telephone line connection, a coaxial cable system, a satellite system, a line-of-site wireless system, a cellular telephone system, etc.

The processor platform 900 of the illustrated example also includes one or more mass storage devices 928 for storing software and/or data. Examples of such mass storage devices 928 include floppy disk drives, hard drive disks, compact disk drives, Blu-ray disk drives, RAID systems, and DVD drives. In some examples, the mass storage device(s) 928 may implement the example data storage 170. Additionally or alternatively, in some examples the volatile memory 914 may implement the example data storage 170.

The machine executable instructions 932 corresponding to the instructions of FIG. 7 may be stored in the mass storage device 928, in the volatile memory 914, in the non-volatile memory 916, in the local memory 913 and/or on a removable non-transitory computer readable storage medium, such as a CD or DVD 936.

From the foregoing, it will be appreciated that example methods, apparatus and articles of manufacture have been disclosed to implement a blockchain-based digital data exchange to enable aggregation of data to support deep learning solutions for big data analytics. Blockchain-based digital data exchanges, as disclosed herein, can provide many benefits over prior data aggregation systems. For example, blockchain-based digital data exchanges, as disclosed herein, enable data owners to determine whether to sell or lease their data, specify conditions on recipients of the data, and obtain monetary reward in return. Also, data access is traceable in blockchain-based digital data exchanges disclosed herein. For example, each data access by a different recipient involves another data transaction, and such transactions are broadcast to the entire blockchain network. The transactions in the blockchain are identified by labels (e.g., hashes) identifying the data, such that data owners can trace each data access. Data access is also controllable in blockchain-based digital data exchanges disclosed herein. For example, the data owner can specify one or more conditions (e.g., constraints) on accessing the data being sold, leased, etc. (e.g., such as how long the data is permitted to be accessed). Smart contract code can be used to automatically enforce such conditions. Data access is also verifiable in blockchain-based digital data exchanges disclosed herein. For example, smart contract code can be used to enforce one or more conditions on how the data is collected to thereby satisfy the requirements of the data recipient (e.g., data buyer). Blockchain-based digital data exchanges, as disclosed herein, utilize blockchains to ensure protected data transactions, thereby eliminating the need for a separate, trusted third party to perform such a function.

The foregoing disclosure provides examples blockchain-based digital data exchange systems. The following further examples, which include subject matter such as a data publisher endpoint device for a blockchain-based digital data exchange system, at least one computer-readable storage medium including instructions that, when executed by at least one processor, cause the at least one processor to implement a data publisher endpoint device for a blockchain-based digital data exchange system, means for implementing a data publisher endpoint device for a blockchain-based digital data exchange system, a method for a data publisher endpoint device in a blockchain-based digital data exchange system, a data subscriber endpoint system for a blockchain-based digital data exchange system, at least one computer-readable storage medium including instructions that, when executed by at least one processor, cause the at least one processor to implement a data subscriber endpoint system for a blockchain-based digital data exchange system, means for implementing a data subscriber endpoint system for a blockchain-based digital data exchange system, and a method for a data subscriber endpoint system in a blockchain-based digital data exchange system are disclosed herein. The disclosed examples can be implemented individually and/or in one or more combinations.

Example 1 is a data publisher endpoint device including a datamart publisher client to transmit a message to a data exchange to publish availability of data to be accessed from data storage associated with the data publisher endpoint device and, in response to a request from a data subscriber endpoint system, initiate a transaction to provide the data subscriber endpoint system with access to the data. The data publisher endpoint device of example 1 also includes a blockchain client to publish a record of the transaction to a blockchain network when the transaction is validated by the datamart publisher client, the record to be included in a blockchain implemented by the blockchain network

Example 2 includes the subject matter of example 1, wherein datamart publisher client is further to determine a label for the data, determine a price for accessing the data, and include the label and the price in the message to transmit to the data exchange to publish the availability of the data.

Example 3 includes the subject matter of example 2, wherein the message is a first message, the request includes a public encryption key associated with the data subscriber endpoint system, and the datamart publisher client is to: encrypt the data with the public encryption key to generate encrypted data; transmit a second message to the data subscriber endpoint system to initiate the transaction, the second message to specify a location at which the encrypted data can be accessed by the data subscriber endpoint system; and receive a response to the second message from the data subscriber endpoint system, the response to indicate whether the transaction is accepted by the data subscriber endpoint system.

Example 4 includes the subject matter of example 3, and further includes a smart contract application to validate the transaction when the response to the second message indicates the transaction has been accepted by the data subscriber endpoint system, the smart contract application to confirm payment of the price by the data subscriber endpoint system to validate the transaction.

Example 5 includes the subject matter of example 4, wherein the record is a first record, and (1) the datamart publisher client is further to determine a condition for accessing the data and to include the condition in the message to transmit to the data exchange to publish the availability of the data, (2) the smart contract application is to monitor access of the data by the data subscriber endpoint system to enforce the condition after the transaction has been validated, and (3) the blockchain client is to publish a second record to the block chain network to update the transaction when the smart contract application determines the condition has been violated by the data subscriber endpoint system.

Example 6 includes the subject matter of example 5, wherein the condition specifies at least one of a duration during which the data is permitted to be accessed or a frequency at which the data is permitted to be accessed.

Example 7 includes the subject matter of example 3, wherein the smart contract application is further to monitor a data producing application of the data publisher endpoint device to enforce a condition for at least one of generating or collecting the data.

Example 8 includes the subject matter of any one of examples 2 to 7, wherein the record is to include a transaction identifier, the label, the price, an identifier associated with the data publisher endpoint device and an identifier associated with the data subscriber endpoint system, and the blockchain client is to transmit the record to computing nodes included in the blockchain network to publish the record to the blockchain network.

Example 9 includes the subject matter of example 8, wherein the label is a first label, the record is a first record and the blockchain client is further to monitor the blockchain for records other than the first record including corresponding labels matching the first label, and notify the datamart publisher client when at least one of the records other than the first record includes a corresponding label matching the first label.

Example 10 includes the subject matter of any one of examples 1 to 9, and further includes a data producing application to provide the data to the data storage associated with the data publisher endpoint device.

Example 11 includes at least one non-transitory computer readable storage medium including computer readable instructions that, when executed, cause at least one processor of a data publisher endpoint device to at least (1) transmit a message to a data exchange to publish availability of data to be accessed from data storage associated with the data publisher endpoint device, (2) initiate a transaction to provide a data subscriber endpoint system with access to the data in response to a request from the data subscriber endpoint system, and (3) publish a record of the transaction to a blockchain network when the transaction is validated, the record to be included in a blockchain implemented by the blockchain network.

Example 12 includes the subject matter of example 11, wherein the computer readable instructions, when executed, further cause the at least one processor to determine a label for the data, determine a price for accessing the data, and include the label and the price in the message to transmit to the data exchange to publish the availability of the data.

Example 13 includes the subject matter of example 12, wherein the message is a first message, the request includes a public encryption key associated with the data subscriber endpoint system, and the computer readable instructions, when executed, cause the at least one processor to: encrypt the data with the public encryption key to generate encrypted data; transmit a second message to the data subscriber endpoint system to initiate the transaction, the second message to specify a location at which the encrypted data can be accessed by the data subscriber endpoint system; and receive a response to the second message from the data subscriber endpoint system, the response to indicate whether the transaction is accepted by the data subscriber endpoint system.

Example 14 includes the subject matter of example 13, wherein the computer readable instructions, when executed, further cause the at least one processor to execute a smart contract application to validate the transaction when the response to the second message indicates the transaction has been accepted by the data subscriber endpoint system, the smart contract application to confirm payment of the price by the data subscriber endpoint system to validate the transaction.

Example 15 includes the subject matter of example 14, wherein the record is a first record, and the computer readable instructions, when executed, further cause the at least one processor to: determine a condition for accessing the data and include the condition in the message to transmit to the data exchange to publish the availability of the data; execute the smart contract application to monitor access of the data by the data subscriber endpoint system to enforce the condition after the transaction has been validated; and publish a second record to the block chain network to update the transaction when the smart contract application determines the condition has been violated by the data subscriber endpoint system.

Example 16 includes the subject matter of example 15, wherein the condition specifies at least one of a duration during which the data is permitted to be accessed or a frequency at which the data is permitted to be accessed.

Example 17 includes the subject matter of example 14, wherein the smart contract application is further to monitor a data producing application of the data publisher endpoint device to enforce a condition for at least one of generating or collecting the data.

Example 18 includes the subject matter of any one of examples 12 to 17, wherein the record is to include a transaction identifier, the label, the price, an identifier associated with the data publisher endpoint device and an identifier associated with the data subscriber endpoint system, and the computer readable instructions, when executed, cause the at least one processor to transmit the record to computing nodes included in the blockchain network to publish the record to the blockchain network.

Example 19 includes the subject matter of example 18, wherein the label is a first label, the record is a first record and the computer readable instructions, when executed, further cause the at least one processor to monitor the blockchain for records other than the first record including corresponding labels matching the first label, and present a notification when at least one of the records other than the first record includes a corresponding label matching the first label.

Example 20 includes the subject matter of any one of examples 11 to 19, wherein the computer readable instructions, when executed, further cause the at least one processor to execute a data producing application to provide the data to the data storage associated with the data publisher endpoint device.

Example 21 is a data subscriber endpoint system including a datamart subscriber client to access a notification from a data exchange, the notification to indicate that a data publisher endpoint device has published availability of data associated with the data publisher endpoint device, and transmit a request to the data publisher endpoint device to initiate a transaction to provide the data subscriber endpoint system with access to the data. The data subscriber endpoint system of claim 21 also includes a blockchain client to publish a record of the transaction to a blockchain network when the transaction is validated by the datamart subscriber client, the record to be included in a blockchain implemented by the blockchain network.

Example 22 includes the subject matter of example 21, wherein the notification is a first notification, and the datamart subscriber client is further to transmit a message to the data exchange to subscribe for data availability notifications, and compare the first notification to one or more criteria to determine whether to request initiation of the transaction to provide the data subscriber endpoint system with access to the data.

Example 23 includes the subject matter of example 22, wherein the datamart subscriber client is further to access a message received from the data publisher endpoint device in response to the request, the message to specify a location at which the data can be accessed by the data subscriber endpoint system, and access the data from the location specified in the message.

Example 24 includes the subject matter of example 23, wherein the request is to include a public encryption key associated with the data subscriber endpoint system, and the datamart subscriber client is further to decrypt the data accessed from the location specified in the message, the datamart subscriber client to decrypt the data based on a private encryption key associated with the public encryption key.

Example 25 includes the subject matter of example 23 or example 24, and further includes a smart contract application to evaluate the data accessed from the location specified in the message to determine whether to validate the transaction, the smart contract application to evaluate the data based on a condition specified for the data in the first notification.

Example 26 includes the subject matter of example 25, wherein the condition specifies at least one of a quantity of the data or a duration covered by the data.

Example 27 includes the subject matter of example 25 or example 26, wherein the record is a first record, the smart contract application is further to monitor the data accessed from the location to enforce the condition after the transaction has been validated, and the blockchain client is to publish a second record to the block chain network to update the transaction when the smart contract application determines the data does not satisfy the condition.

Example 28 includes the subject matter of any one of examples 21 to 27, and further includes an application to process the data.

Example 29 includes at least one non-transitory computer readable storage medium including computer readable instructions that, when executed, cause at least one processor of a data subscriber endpoint system to at least (1) access a notification from a data exchange, the notification to indicate that a data publisher endpoint device has published availability of data associated with the data publisher endpoint device, (2) transmit a request to the data publisher endpoint device to initiate a transaction to provide the data subscriber endpoint system with access to the data, and (3) publish a record of the transaction to a blockchain network when the transaction is validated, the record to be included in a blockchain implemented by the blockchain network.

Example 30 includes the subject matter of example 29, wherein the notification is a first notification, and the computer readable instructions, when executed, further cause the at least one processor to transmit a message to the data exchange to subscribe for data availability notifications, and compare the first notification to one or more criteria to determine whether to request initiation of the transaction to provide the data subscriber endpoint system with access to the data.

Example 31 includes the subject matter of example 30, wherein the computer readable instructions, when executed, further cause the at least one processor to access a message received from the data publisher endpoint device in response to the request, the message to specify a location at which the data can be accessed by the data subscriber endpoint system, and access the data from the location specified in the message.

Example 32 includes the subject matter of example 31, wherein the request is to include a public encryption key associated with the data subscriber endpoint system, and the computer readable instructions, when executed, further cause the at least one processor to decrypt the data accessed from the location specified in the message, the data to be decrypted based on a private encryption key associated with the public encryption key.

Example 33 includes the subject matter of example 31 or example 32, wherein the computer readable instructions, when executed, further cause the at least one processor to execute a smart contract application to evaluate the data accessed from the location specified in the message to determine whether to validate the transaction, the smart contract application to evaluate the data based on a condition specified for the data in the first notification.

Example 34 includes the subject matter of example 33, wherein the condition specifies at least one of a quantity of the data or a duration covered by the data.

Example 35 includes the subject matter of example 33 or example 34, wherein the record is a first record, and the computer readable instructions, when executed, further cause the at least one processor to execute the smart contract application to further monitor the data accessed from the location to enforce the condition after the transaction has been validated, and publish a second record to the block chain network to update the transaction when the smart contract application determines the data does not satisfy the condition.

Example 36 includes the subject matter of any one of examples 29 to 35, wherein the computer readable instructions, when executed, further cause the at least one processor to execute an application to process the data.

Example 37 is a method including transmitting, by executing an instructions with a processor of a data publisher endpoint device, a message to a data exchange to publish availability of data to be accessed from data storage associated with the data publisher endpoint device. The method of example 37 also includes initiating, by executing an instructions with the processor, a transaction to provide a data subscriber endpoint system with access to the data in response to a request from the data subscriber endpoint system. The method of example 37 further includes publishing, by executing an instructions with the processor, a record of the transaction to a blockchain network when the transaction is validated, the record to be included in a blockchain implemented by the blockchain network.

Example 38 includes the subject matter of example 37, wherein the method further includes determining a label for the data, determining a price for accessing the data, and including the label and the price in the message to transmit to the data exchange to publish the availability of the data.

Example 39 includes the subject matter of example 38, wherein the message is a first message, the request includes a public encryption key associated with the data subscriber endpoint system, and the method further includes encrypting the data with the public encryption key to generate encrypted data; transmitting a second message to the data subscriber endpoint system to initiate the transaction, the second message to specify a location at which the encrypted data can be accessed by the data subscriber endpoint system; and receiving a response to the second message from the data subscriber endpoint system, the response to indicate whether the transaction is accepted by the data subscriber endpoint system.

Example 40 includes the subject matter of example 39, wherein the method further includes executing a smart contract application to validate the transaction when the response to the second message indicates the transaction has been accepted by the data subscriber endpoint system, the smart contract application to confirm payment of the price by the data subscriber endpoint system to validate the transaction.

Example 41 includes the subject matter of example 40, wherein the record is a first record, and the method further includes: determining a condition for accessing the data and include the condition in the message to transmit to the data exchange to publish the availability of the data; executing the smart contract application to monitor access of the data by the data subscriber endpoint system to enforce the condition after the transaction has been validated; and publishing a second record to the block chain network to update the transaction when the smart contract application determines the condition has been violated by the data subscriber endpoint system.

Example 42 includes the subject matter of example 41, wherein the condition specifies at least one of a duration during which the data is permitted to be accessed or a frequency at which the data is permitted to be accessed.

Example 43 includes the subject matter of example 40, wherein the smart contract application is further to monitor a data producing application of the data publisher endpoint device to enforce a condition for at least one of generating or collecting the data.

Example 44 includes the subject matter of any one of examples 38 to 43, wherein the record is to include a transaction identifier, the label, the price, an identifier associated with the data publisher endpoint device and an identifier associated with the data subscriber endpoint system, and the method further includes transmitting the record to computing nodes included in the blockchain network to publish the record to the blockchain network.

Example 45 includes the subject matter of example 44, wherein the label is a first label, the record is a first record and the method further includes monitoring the blockchain for records other than the first record including corresponding labels matching the first label, and presenting a notification when at least one of the records other than the first record includes a corresponding label matching the first label.

Example 46 includes the subject matter of any one of examples 37 to 45, wherein the method further includes executing a data producing application to provide the data to the data storage associated with the data publisher endpoint device.

Example 47 is a method including access, by executing an instruction with a processor of a data subscriber endpoint system, a notification from a data exchange, the notification to indicate that a data publisher endpoint device has published availability of data associated with the data publisher endpoint device. The method of example 47 also includes transmitting a request to the data publisher endpoint device to initiate a transaction to provide the data subscriber endpoint system with access to the data. The method of example 47 further includes publishing a record of the transaction to a blockchain network when the transaction is validated, the record to be included in a blockchain implemented by the blockchain network.

Example 48 includes the subject matter of example 47, wherein the notification is a first notification, and the method further includes transmitting a message to the data exchange to subscribe for data availability notifications, and comparing the first notification to one or more criteria to determine whether to request initiation of the transaction to provide the data subscriber endpoint system with access to the data.

Example 49 includes the subject matter of example 48, wherein the method further includes accessing a message received from the data publisher endpoint device in response to the request, the message to specify a location at which the data can be accessed by the data subscriber endpoint system, and accessing the data from the location specified in the message.

Example 50 includes the subject matter of example 49, wherein the request is to include a public encryption key associated with the data subscriber endpoint system, and the method further includes decrypting the data accessed from the location specified in the message, the data to be decrypted based on a private encryption key associated with the public encryption key.

Example 51 includes the subject matter of example 49 or example 50, wherein the method further includes executing a smart contract application to evaluate the data accessed from the location specified in the message to determine whether to validate the transaction, the smart contract application to evaluate the data based on a condition specified for the data in the first notification.

Example 52 includes the subject matter of example 51, wherein the condition specifies at least one of a quantity of the data or a duration covered by the data.

Example 53 includes the subject matter of example 51 or example 52, wherein the record is a first record, and the smart contract application is further to monitor the data accessed from the location to enforce the condition after the transaction has been validated, and publish a second record to the block chain network to update the transaction when the smart contract application determines the data does not satisfy the condition.

Example 54 includes the subject matter of any one of examples 47 to 53, wherein the method further includes executing an application to process the data.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A data publisher endpoint device comprising:
a datamart publisher client to:
transmit a message to a data exchange to publish availability of data to be accessed from data storage associated with the data publisher endpoint device; and
in response to a request from a data subscriber endpoint system, initiate a transaction to provide the data subscriber endpoint system with access to the data; and
a blockchain client to publish a record of the transaction to a blockchain network when the transaction is validated by the datamart publisher client, the record to be included in a blockchain implemented by the blockchain network.

2. The data publisher endpoint device of claim 1, wherein datamart publisher client is further to:
determine a label for the data;
determine a price for accessing the data; and
include the label and the price in the message to transmit to the data exchange to publish the availability of the data.

3. The data publisher endpoint device of claim 2, wherein the message is a first message, the request includes a public encryption key associated with the data subscriber endpoint system, and the datamart publisher client is to:
encrypt the data with the public encryption key to generate encrypted data;
transmit a second message to the data subscriber endpoint system to initiate the transaction, the second message to specify a location at which the encrypted data can be accessed by the data subscriber endpoint system; and
receive a response to the second message from the data subscriber endpoint system, the response to indicate whether the transaction is accepted by the data subscriber endpoint system.

4. The data publisher endpoint device of claim 3, further including a smart contract application to validate the transaction when the response to the second message indicates the transaction has been accepted by the data subscriber endpoint system, the smart contract application to confirm payment of the price by the data subscriber endpoint system to validate the transaction.

5. The data publisher endpoint device of claim 4, wherein the record is a first record, and:
the datamart publisher client is further to determine a condition for accessing the data and to include the condition in the message to transmit to the data exchange to publish the availability of the data;
the smart contract application is to monitor access of the data by the data subscriber endpoint system to enforce the condition after the transaction has been validated; and
the blockchain client is to publish a second record to the block chain network to update the transaction when the smart contract application determines the condition has been violated by the data subscriber endpoint system.

6. (canceled)

7. (canceled)

8. The data publisher endpoint device of claim 2, wherein the record is to include a transaction identifier, the label, the price, an identifier associated with the data publisher endpoint device and an identifier associated with the data subscriber endpoint system, and the blockchain client is to transmit the record to computing nodes included in the blockchain network to publish the record to the blockchain network.

9. The data publisher endpoint device of claim 8, wherein the label is a first label, the record is a first record and the blockchain client is further to:
monitor the blockchain for records other than the first record including corresponding labels matching the first label; and
notify the datamart publisher client when at least one of the records other than the first record includes a corresponding label matching the first label.

10. (canceled)

11. At least one non-transitory computer readable storage medium comprising computer readable instructions that, when executed, cause at least one processor of a data publisher endpoint device to at least:
transmit a message to a data exchange to publish availability of data to be accessed from data storage associated with the data publisher endpoint device;
initiate a transaction to provide a data subscriber endpoint system with access to the data in response to a request from the data subscriber endpoint system; and
publish a record of the transaction to a blockchain network when the transaction is validated, the record to be included in a blockchain implemented by the blockchain network.

12. The storage medium of claim 11, wherein the computer readable instructions, when executed, further cause the at least one processor to:
determine a label for the data;
determine a price for accessing the data; and
include the label and the price in the message to transmit to the data exchange to publish the availability of the data.

13. The storage medium of claim 12, wherein the message is a first message, the request includes a public encryption key associated with the data subscriber endpoint system, and the computer readable instructions, when executed, cause the at least one processor to:
encrypt the data with the public encryption key to generate encrypted data;
transmit a second message to the data subscriber endpoint system to initiate the transaction, the second message to specify a location at which the encrypted data can be accessed by the data subscriber endpoint system; and
receive a response to the second message from the data subscriber endpoint system, the response to indicate whether the transaction is accepted by the data subscriber endpoint system.

14. The storage medium of claim 13, wherein the computer readable instructions, when executed, further cause the at least one processor to execute a smart contract application to validate the transaction when the response to the second message indicates the transaction has been accepted by the data subscriber endpoint system, the smart contract application to confirm payment of the price by the data subscriber endpoint system to validate the transaction.

15. The storage medium of claim 14, wherein the record is a first record, and the computer readable instructions, when executed, further cause the at least one processor to:
determine a condition for accessing the data and include the condition in the message to transmit to the data exchange to publish the availability of the data;
execute the smart contract application to monitor access of the data by the data subscriber endpoint system to enforce the condition after the transaction has been validated; and
publish a second record to the block chain network to update the transaction when the smart contract application determines the condition has been violated by the data subscriber endpoint system.

16. (canceled)

17. (canceled)

18. The storage medium of claim 12, wherein the record is to include a transaction identifier, the label, the price, an identifier associated with the data publisher endpoint device and an identifier associated with the data subscriber endpoint system, and the computer readable instructions, when executed, cause the at least one processor to transmit the record to computing nodes included in the blockchain network to publish the record to the blockchain network.

19. The storage medium of claim 18, wherein the label is a first label, the record is a first record and the computer readable instructions, when executed, further cause the at least one processor to:
monitor the blockchain for records other than the first record including corresponding labels matching the first label; and
present a notification when at least one of the records other than the first record includes a corresponding label matching the first label.

20. (canceled)

21. A data subscriber endpoint system comprising:
a datamart subscriber client to:
access a notification from a data exchange, the notification to indicate that a data publisher endpoint device has published availability of data associated with the data publisher endpoint device; and
transmit a request to the data publisher endpoint device to initiate a transaction to provide the data subscriber endpoint system with access to the data; and
a blockchain client to publish a record of the transaction to a blockchain network when the transaction is validated by the datamart subscriber client, the record to be included in a blockchain implemented by the blockchain network.

22. The data subscriber endpoint system of claim 21, wherein the notification is a first notification, and the datamart subscriber client is further to:
transmit a message to the data exchange to subscribe for data availability notifications; and
compare the first notification to one or more criteria to determine whether to request initiation of the transaction to provide the data subscriber endpoint system with access to the data.

23. The data subscriber endpoint system of claim 22, wherein the datamart subscriber client is further to:
access a message received from the data publisher endpoint device in response to the request, the message to specify a location at which the data can be accessed by the data subscriber endpoint system; and
access the data from the location specified in the message.

24. The data subscriber endpoint system of claim 23, wherein the request is to include a public encryption key associated with the data subscriber endpoint system, and the datamart subscriber client is further to decrypt the data accessed from the location specified in the message, the datamart subscriber client to decrypt the data based on a private encryption key associated with the public encryption key.

25. The data subscriber endpoint system of claim 23, further including a smart contract application to evaluate the data accessed from the location specified in the message to determine whether to validate the transaction, the smart contract application to evaluate the data based on a condition specified for the data in the first notification.

26. (canceled)

27. The data subscriber endpoint system of claim 25, wherein the record is a first record, and:
the smart contract application is further to monitor the data accessed from the location to enforce the condition after the transaction has been validated; and
the blockchain client is to publish a second record to the block chain network to update the transaction when the smart contract application determines the data does not satisfy the condition.

28. (canceled)

29. At least one non-transitory computer readable storage medium comprising computer readable instructions that, when executed, cause at least one processor of a data subscriber endpoint system to at least:
access a notification from a data exchange, the notification to indicate that a data publisher endpoint device has published availability of data associated with the data publisher endpoint device;
transmit a request to the data publisher endpoint device to initiate a transaction to provide the data subscriber endpoint system with access to the data; and
publish a record of the transaction to a blockchain network when the transaction is validated, the record to be included in a blockchain implemented by the blockchain network.

30. The storage medium of claim 29, wherein the notification is a first notification, and the computer readable instructions, when executed, further cause the at least one processor to:
transmit a message to the data exchange to subscribe for data availability notifications; and
compare the first notification to one or more criteria to determine whether to request initiation of the transaction to provide the data subscriber endpoint system with access to the data.

31. The storage medium of claim 30, wherein the computer readable instructions, when executed, further cause the at least one processor to:
access a message received from the data publisher endpoint device in response to the request, the message to specify a location at which the data can be accessed by the data subscriber endpoint system; and
access the data from the location specified in the message.

32. The storage medium of claim 31, wherein the request is to include a public encryption key associated with the data subscriber endpoint system, and the computer readable instructions, when executed, further cause the at least one processor to decrypt the data accessed from the location specified in the message, the data to be decrypted based on a private encryption key associated with the public encryption key.

33. The storage medium of claim 31, wherein the computer readable instructions, when executed, further cause the at least one processor to execute a smart contract application to evaluate the data accessed from the location specified in the message to determine whether to validate the transaction, the smart contract application to evaluate the data based on a condition specified for the data in the first notification.

34. (canceled)

35. The storage medium of claim 33, wherein the record is a first record, and the computer readable instructions, when executed, further cause the at least one processor to:
execute the smart contract application to further monitor the data accessed from the location to enforce the condition after the transaction has been validated; and
publish a second record to the block chain network to update the transaction when the smart contract application determines the data does not satisfy the condition.

36. (canceled)
